(19) United States
(12) Patent Application Publication
(10) Pub. No.: US 2007/0195814 A1
(43) Pub. Date: Aug. 23, 2007

(54) Integrated Circuit Apparatus And Method for High Throughput Signature Based Network Applications

(75) Inventors: Robert Matthew Barrie, Double Bay (AU); Stephen Gould, Killara (AU); Darren Williams, Newtown (AU); Nicholas de Jong, Bondi Junction (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sensory Networks, Inc., Palo Alto, CA (US)

(21) Appl. No.: 11/539,603

(22) Filed: Oct. 6, 2006

Related U.S. Application Data
(63) Continuation of application No. 10/640,870, filed on Aug. 13, 2003.

(51) Int. Cl. H04L 12/66

(52) U.S. Cl. 370/463

(57) ABSTRACT

An architecture for an integrated circuit apparatus and method that allows significant performance improvements for signature based network applications. In various embodiments the architecture allows high throughput classification of packets into network streams, packet reassembly of such streams, filtering and pre-processing of such streams, pattern matching on header and payload content of such streams, and action execution based upon rule-based policy for multiple network applications, simultaneously at wire speed. The present invention is improved over the prior art designs, in performance, flexibility and pattern database size.

### CROSS-REFERENCES TO RELATED APPLICATIONS

The present application is a continuation of and claims priority to U.S. application Ser. No. 10/640,870, filed Aug. 13, 2003, entitled “Integrated Circuit Apparatus And Method For High Throughput Signature Based Network Applications”, the content of which is incorporated herein by reference in its entirety.

### BACKGROUND OF THE INVENTION

The invention relates to computer networking security applications. More particularly, the invention includes an integrated circuit implementation of an apparatus for signature based network applications acting upon network packets and stream data at wire-speed. According to a specific embodiment, the invention includes an apparatus and method for high throughput flow classification of packets into network streams, packet reassembly of such streams (where desired), filtering and pre-processing of such streams (including protocol decoding where desired), pattern matching on header and payload content of such streams, and action execution based upon rule-based policy for multiple network applications, simultaneously at wire speed. Merely by way of example, the invention has been applied to networking devices, which are been distributed throughout local, wide area, and world wide area networks.

As the world progresses, internetworking of computers has become important for infrastructure for enterprises, communication systems, countries and the world. The data flowing between computers is increasingly more important in terms of both the content carried and the timeliness of delivery. Through the technological advances in computing and networking, large databases are now available and in use by parties on opposite sides of the globe.

Data are carried between computers across networks, such as the Internet, in small quantities usually known as packets. Where an amount of data is too big to fit into a single packet (the size of which is typically defined by the characteristics of the network over which the packet will flow), a series of packets is used to carry the data from one end of the communication channel to the other. This series, or stream as it is commonly referred to, is then reassembled from the individual packets into the original data at the receiving end.

Packets are routed between computers using specially developed algorithms that allow computers and network equipment to decide along which path the packet should be sent to arrive at its final destination. These algorithms examine the packet header (typically a fixed sized portion of the packet containing information such as the source and destination address of the packet added to the payload to be transported) to make routing decisions. The algorithms need to examine the packet and make the decision very quickly to allow large numbers of packets to be sent with very small delay. As well as examining the header, the contents of the packet may be examined for information to aid in making decisions about the path and priority given to a packet; this examination of the data however adds an overhead that can limit the throughput and delay imposed by the device examining the data—typically the more data to be searched the longer the delay incurred by searching it.

Increasingly, as packets are sent from their source to their destination they are examined not just to help in routing decisions but for other purposes as well. A piece of email, which is sent across a network as a series of packets may be examined to see if it is an unwanted email message (commonly referred to as ‘spam’); this examination often desires looking at the contents of the message, which is the payload portion of the packets involved in carrying the email. Similarly the email may be scanned to see if it contains a computer virus. Packets may also be examined to look for copyright infringements, illegal activity such as computer ‘hacking’ or corporate espionage, or simply to analyze usage to offer a better quality of service. By examining packets in a network new applications are now being offered, and it can reasonably be expected that new network applications based on the examining of packets will continue to be developed.

Specialized network equipment is able to examine packet headers (with their small total size, set protocol and fixed layout) very quickly. However, to examine a packet's data payload, which is not always well structured, is complex and can be hard to do in the small window of time available to process each packet. This problem is compounded when one must often analyze this payload in context of data structures and protocols, and even further in the face of malicious obfuscation by a sophisticated attacker. Typically appliances such as email gateways, intrusion detection systems and general content protection appliances search the network data in software which, while often flexible and highly optimized, still comes nowhere near approaching the desired speeds, in terms of total throughput or delay. Appliances may also use specialized routing hardware which is strictly limited to examining headers. Furthermore, these software and hardware appliances typically impose quite severe restrictions on what data can be searched for, and the number of different patterns that can be matched simultaneously.

Network equipment also works under several constraints; the total time that a packet takes to get from an ingress interface to an egress interface needs to be kept to a minimum. The time it takes for a packet to travel through a communication device or channel is called latency. The latency introduced by a device must not only be kept to a minimum, but must also be kept relatively constant; change in latency, is known as jitter. Jitter, in particular, adversely affects multimedia streams. With current software-based network applications, jitter is difficult to control as the software is usually sharing a single CPU with many other processes, compounded by most general purpose operating systems not providing support for real-time processing. As a result, software application interactions can result in a dramatic detrimental effect on network performance. As networks run at faster and faster speeds, this effect is compounded.

The way many network protocols organize the carrying of packets across communication networks means that the packets involved in carrying a given stream may not always arrive in the correct order and, further, packets may end up being fragmented due to a variety of reasons. To handle these cases the end receiver of a stream needs to reconstruct fragmented packets using networking algorithms and reassemble the stream from the packets, irrespective of the order in which they arrive. This does however impose additional demands on appliances or applications that wish to examine the data belonging to a stream in its full context, rather than just taking it out of context as a single packet. Routing and other decisions are typically done wholly on the information provided within the single packet, but if a particular pattern is being searched for in a stream, it is desirable to find it even if it spans across the boundaries between two or more packets. Thus, to do proper searching of streams it is essential to provide some mechanism for dealing with fragmented and out of order packets.

Searching in networking and other computer disciplines can be done in a variety of ways. Typically a set of “rules” or “patterns” is used to describe the contents to be searched for, and then algorithms are used that apply these “rules” or “patterns” across the data to be searched. These are often described using a construct known as a regular language. Regular languages are most often expressed as regular expressions. Regular languages and expressions are well known prior art, but come in a variety of different types, some of which are standardized, some are not. Once an expression to be searched for has been defined as a regular expression it is typically acted upon by an algorithm to produce what is known as a finite automaton. This finite automaton can be “executed” to search for patterns; this execution involves the calculation of a transition function, which defines transitions from one state of the finite automaton to another state of the finite automaton, each transition being triggered by a single piece of input, called a symbol, from the data being searched.

High speed searching of data streams given a set of constraints, including the reassembly of the streams, a large pattern database comprising thousands of patterns, at high throughput with low delay, is complex and difficult to achieve. Current methods generally require software running on general purpose CPUs and have great difficulty meeting all the constraints; some manage by sacrificing several of the goals, such as drastically limiting the size of the pattern database, and the form those patterns can take. Some current methods use specialized hardware solutions, with application specific integrated circuits to attempt to meet the competing needs. This does not provide a comprehensive general solution, and often fails to address the hard problems such as allowing large pattern databases. These and possibly other limitations of these conventional techniques can be found throughout the present specification and more particularly below.

What is needed is a way of searching computer network traffic for patterns at higher (e.g., current network speeds), without placing undue restrictions on the size, complexity or number of patterns. This can be achieved using specialized technology, and is the subject of this invention.

### SUMMARY OF INVENTION

According to the present invention, techniques for computer networking security applications are provided. More particularly, the invention includes an integrated circuit implementation of an apparatus for signature based network applications acting upon network packets and stream data at wire-speed. According to a specific embodiment, the invention includes an apparatus and method for high throughput (e.g., 10,000,000 bits per second and greater) flow classification of packets into network streams, packet reassembly of such streams (where desired), filtering and pre-processing of such streams (including protocol decoding where desired), pattern matching on header and payload content of such streams, and action execution based upon rule-based policy for multiple network applications, simultaneously at wire speed. Merely by way of example, the invention has been applied to networking devices, which are been distributed throughout local, wide area, and world wide area networks.

In a specific embodiment, the invention provides an integrated circuit apparatus for high throughput pattern matching in network applications. The apparatus comprises a rigid support member (e.g., printed circuit board, substrate, silicon substrate, integrated circuit module) comprising a connector region, which has a network connection region and a host connection region. The rigid support member has a selected width and a selected length. The selected width and selected length are adapted to couple via the connector region into a network system. Preferably, the connector region is directly connected into a common interface bus. One or more hardware modules (e.g., integrated circuits, integrated circuit modules) is disposed (e.g., solder bumps) onto and coupled to the rigid support member. Preferably, the one or more hardware modules includes a network interface module coupled to the rigid support member.

Preferably, the network interface module includes one or more network interface ports. The one or more network interface ports is coupled via the connector region to a packet based network. The one or more network interface ports contains one or more ingress network ports. A network interface bus is coupled to the rigid support member. The network interface bus is adapted to interface the network interface module to the network module. A network module is coupled to the rigid support member. The network module is coupled to the network interface bus. A network event module is coupled to the rigid support member. The network event module is coupled to the network module. A memory module is coupled to the rigid support member and the memory module is coupled to the network event module and the network module. The memory module includes a pattern memory. The pattern memory is associated with a plurality of pre-stored patterns. A host interface module is coupled to the rigid support member and is coupled to the network event module, or the network module, or both. A host interface bus is coupled to the rigid support member. The host interface bus is coupled to the host interface module and is capable of connecting to the host system via the connector region. In a specific embodiment, the invention can use one or more pre-stored patterns. The pre-stored patterns can include regular expressions, n-gram expressions (e.g., tuple of symbols), among others. In a specific embodiment, the one or more network interface ports further comprise one or more egress network ports coupled to the packet based network. The one or more egress network ports may be a response port adapted to facilitate communications to a remote network system via a signal, where the signal may include one or more messages, and an update module may be used to update the one or more messages. Merely by way of example, the signal may be related to a match detected by a feature extractor. In another example, the signal may be related to an output of the network event module. The remote network system may be selected from a group consisting of firewall, network management system, intrusion prevention system, router, network switch, and logging system. In a specific embodiment, the signatures used by the apparatus are selected from a plurality of patterns defined according to a language selected from: a regular language; a temporal regular language; a Berkeley packet filter language; a Linux packet filter language; an approximate pattern language; and a Perl compatible regular expression language.

Preferably, the memory module additionally comprises a feature memory; which is associated with a plurality of pre-stored features. A rule memory is also associated with a plurality of pre-stored rules. The network module includes a feature extraction device, which is coupled to the network module and the memory module. The feature extraction device is also capable of identifying a feature association according to a feature extraction algorithm. According to a specific embodiment, the feature extraction algorithm identifies a feature association based upon examination of one or more packets according to some pre-determined functionality. The feature association identifies one or more of a plurality of pre-stored features. The pre-stored features are stored in a feature memory. A policy device is coupled to the feature extraction device and the memory module. The policy device identifies a rule association based upon the feature association identified by the feature extraction device according to a policy algorithm. The policy algorithm identifies the rule association by examining the feature association according to some pre-determined functionality. The rule association identifies one or more of a plurality of pre-stored rules, which are stored in a rule memory. According to a specific embodiment, one or more of pre-stored rules are related to a counting component, where the counting component includes a counter and a threshold. The threshold is compared against the value of the counter. According to a specific embodiment, the feature extraction device further includes an approximate pattern matching module adapted to perform approximate pattern matching on one or more of the pre-stored patterns. According to a specific embodiment, the identified rule association signals an action causing a change in a state of the apparatus. The action may enable, for a pre-determined time period, a selection of one or more pre-stored rules in the rule memory. According to a specific embodiment, one or more of the pre-stored rules include a temporal element. Merely by way of example, the temporal element may be related to at least one of a quantity of time, an absolute time, infinity and zero. In another example, the temporal element may be related to a counting component, where the counting component includes a counter and a threshold, and the threshold is compared to the counter. The combined temporal and counter components may define a rate of change. According to a specific embodiment, the policy device is coupled to a host interface module and is adapted to supply the host interface module with the identified rule association. The host interface module may be coupled to a host connector region, where the host connector region is selected from a group consisting of: peripheral components interface (PCI); compact peripheral components interface (compact PCI); peripheral components interface x (PCI-X); peripheral components interface express (PCI-express); universal serial bus (USB); small computer systems interface (SCSI); and ISA bus. According to a specific embodiment, the network module, the network interface module, the network event module and the network interface module are provided on a single integrated circuit. The single integrated circuit may be a reconfigurable logic circuit.

According to a specific embodiment, the feature extraction algorithm can be an approximate pattern matching process for at least one or more of the predetermined patterns. Preferably, the approximate pattern matching process is performed on streams of data from text files of data, text streams of data, binary files of data, binary streams of data, audio streams of data, audio files of data, video streams of data, video files of data, multimedia streams of data, and multimedia files of data, any combination of these, and the like. In alternative embodiment, the measure of approximation in the approximate pattern matching process is an edit distance, which can be the number of insertions, deletions or substitutions desired to exactly match the pattern. The measure of approximation in the approximate pattern matching process can also be related to human perception, among other factors.

In an alternative specific embodiment, the invention provides a method for performing high throughput pattern matching. The high throughput pattern matching operation is performed using one or more of a plurality of patterns; which are defined by a Regular Language as understood in the art. The patterns are defined by a Regular Language. The Regular Language is implemented as a Finite Automaton. The Finite Automaton includes a transition table representation of the Regular Language. The transition table describes a transition function for the Finite Automaton. The transition table is adapted to be stored in a compressed form. The compressed form is adapted such that the transition function of the Finite Automaton is able to be computed from the compressed form in a maximum time that is constant with respect to the size of the compressed form. Preferably, the pattern matching is provided at wire speed in an efficient and cost effective manner.

In yet an alternative specific embodiment, the invention provides an apparatus for performing high throughput pattern matching. The high throughput pattern matching operation is performed using one or more of a plurality of patterns. The patterns are represented as a single pattern database. The single pattern database comprises the patterns from one or more of a plurality of applications. The pattern matching operation is able to uniquely identify the application from the matching pattern. The Finite Automaton includes a transition table representation of the Regular Language. The transition table describes a transition function for the Finite Automaton.

In still a further alternative embodiment, the invention provides a method for converting a network system into an accelerated signature based network system. The method includes providing a network system. The network system comprises a host memory coupled to the host processor, a host interface bus coupled to the host processor, and a host connector coupled to the host interface bus. The method also includes providing an Integrated Circuit Apparatus for high throughput pattern matching for network applications. The apparatus a rigid support member comprises a connector region, which includes a network connection region and a host connection region. The rigid support member has a selected width and a selected length. The selected width and selected length are adapted to couple via the connector region into a network system.

Preferably, one or more hardware modules is disposed onto and coupled to the rigid support member. The one or more hardware modules includes a Network Interface Module coupled to the rigid support member. The Network Interface Module includes one or more network interface ports. The one or more network interface ports is coupled via the connector region to a Packet Based Network. The one or more network interface ports contains one or more ingress network ports. A Network Interface Bus is coupled to the rigid support member. The Network Interface Bus is adapted to interface the Network Interface Module to the Network Module. A Network Module is coupled to the rigid support member. The Network Module is coupled to the Network Interface Bus. A Network Event Module is coupled to the rigid support member. The Network Event Module is coupled to the Network Module. A Memory Module is coupled to the rigid support member. The Memory Module is coupled to the Network Event Module and the Network Module. The Memory Module includes a Pattern Memory. The Pattern Memory is associated with a plurality of pre-stored patterns. A Host Interface Module is coupled to the rigid support member. The Host Interface Module is coupled to the Network Event Module and/or the Network Module. A Host Interface Bus is coupled to the rigid support member. The Host Interface Bus is coupled to the Host Interface Module. The Host Interface Bus is capable of connecting to the host system via the connector region. The method includes connecting the host interface connector region of the Integrated Circuit Apparatus with the host connector on the network system to mechanically and electrically couple the host interface bus of the network system to the host interface bus of the Integrated Circuit Apparatus.

Additionally, the method includes transferring selected driver software to the network system. The driver software is configured to facilitate communication between the Integrated Circuit Apparatus and the network system via the host interface bus. The method includes initializing the Integrated Circuit Apparatus via the driver software.

In an alternative specific embodiment, the invention provides a method for signature based pattern recognition using an Integrated Circuit Apparatus. The method includes providing an Integrated Circuit Apparatus for high throughput pattern matching for network applications. The apparatus includes a rigid support member comprising a connector region. The connector region includes a network connection region and a host connection region. The rigid support member has a selected width and a selected length. The selected width and selected length are adapted to couple via the connector region into a network system.

Preferably, one or more hardware modules is disposed onto and coupled to the rigid support member. The one or more hardware modules including A Network Interface Module coupled to the rigid support member. The Network Interface Module includes one or more network interface ports. The one or more network interface ports is coupled via the connector region to a Packet Based Network. The one or more network interface ports contains one or more ingress network ports. A Network Interface Bus is coupled to the rigid support member. The Network Interface Bus is adapted to interface the Network Interface Module to the Network Module. A Network Module is coupled to the rigid support member. The Network Module is coupled to the Network Interface Bus. A Network Event Module is coupled to the rigid support member. The Network Event Module is coupled to the Network Module. A Memory Module is coupled to the rigid support member. The Memory Module is coupled to the Network Event Module and the Network Module. The Memory Module can comprise a range of physical memory devices including, but not limited, to random access memories (RAM), content addressable memories (CAM), and ternary content addressable memories (TCAM). The Pattern Memory is contained within the Memory Module and is associated with a plurality of pre-stored patterns. A Host Interface Module is coupled to the rigid support member. The Host Interface Module is coupled to the Network Event Module and/or the Network Module. A Host Interface Bus is coupled to the rigid support member. The Host Interface Bus is coupled to the Host Interface Module. The Host Interface Bus is capable of connecting to the host system via the connector region.

Additionally, the method includes transferring information from a Packet Based Network to a network interface port and transferring the information from the network interface port through a network interface bus. The method includes receiving the information from the network interface bus at a processing unit and identifying an association between one or more packets and a flow from the information using the processing unit. The one or more packets are reordered into one or more respective flows. The method also includes determining if the one or more packets for the one or more respective flows is associated with a signature based pattern stored in memory through a memory bus coupled to the processing unit, where upon the determining occurs using the memory having a random access time of less than 8 nanoseconds. A signal is initiated to a policy engine based upon the determining step.

Numerous benefits and/or advantages can be performed using the present invention over conventional techniques. According to a preferred embodiment, the invention can also perform pattern matching with high throughput. For embodiments of the invention where Finite Automata are used to implement the pattern matching as part of the Feature Extraction Device, the transition function used by the Finite Automaton should have a constant time complexity that guarantees transitions can be achieved within a fixed bound, the fixed bound being defined by the throughput to be achieved. This is achieved, in part, by using memories with low random access times, such as modern static RAMs.

In an alternative specific embodiment, the invention also conserves memory usage by the pattern database, without unduly restricting the number of patterns in the pattern database. This can be achieved using compression technologies such as those described in U.S. provisional patent 60/473,373 filed May 23, 2003, commonly assigned, and titled “Apparatus and Method for Large Hardware Finite State Machine with Embedded Equivalence,” and U.S. provisional patent No. 60/454,398 filed on Mar. 12, 2003, commonly assigned, and titled “Apparatus and Method for Memory Efficient Programmable Pattern Matching Finite State Machine Hardware.” Alternatively, other similar technologies, obvious to those trained in the art, to reduce the size of the memory footprint for the transition tables can also be used. A key to these technologies is their low and constant latency overhead, which not only results in compact memory usage, but also high throughput. This lower memory usage results in either a lower cost for production of a given system, or a larger capacity of signatures for a given cost of system.

Alternatively, the present invention including the apparatus can be adapted to fit within a wide range of existing and new network systems by being of a generic form factor and connecting through a standard hardware interface requiring no hardware re-engineering of the network system in order for it to be adapted to use the apparatus. Multiple applications can run simultaneously. The multiple applications are able to have separate databases and separate rule databases yet have the hardware apparatus run all applications simultaneously at wire speed; wire speed being the maximum throughput possible for the given physical medium in use according to other embodiments. In other aspects, the invention provides pattern databases, rule sets, and hence applications that can be updated through the host or the network without manual intervention as either new signatures are provided or new applications. The architecture being designed in such a way as to provide a common format for signature based services.

Still further, the invention provides for minimizing upper bound worst case jitter and latency. This is accomplished through implementing core network functions in hardware, rather than in software such as in the kernel of a computer operating system or in a software TCP/IP stack. Furthermore combining these network functions with pattern matching functions in hardware, so that they are tightly coupled, results in a system with lower latency and jitter.

Still further, this invention allows for protocol decoding to be tightly coupled to these network and pattern matching functions so that, in hardware, packets can: be received, classified and reordered; be decoded according to protocol definitions, and have multiple application pattern matching applied. The result of this is that systems can now gain a deeper understanding of network traffic at wire speed, resulting in more accurate signature matching, while also resulting in a system with lower latency and jitter.

Additionally, the invention allows for regular expressions that can be searched for in some embodiments of the invention be further extended to include “temporal regular expressions”. Temporal regular expressions being any expanded set of regular expressions that contain a temporal component. This temporal component allows searching across the data content, but with the additional benefit of being able to utilize information about relative and absolute timing information.

It is a further benefit of this invention to overcome quality of service problems with running network and pattern matching algorithms used in security applications in software according to a specific embodiment. A class of denial of service attacks exploiting algorithmic deficiencies has emerged exacerbating the existing inability to process network data byte by byte in real-time. These low-bandwidth attacks exploit the fact that many algorithms that run in software have ‘average case’ running times that are much more efficient than ‘worst case’ running times. An attacker, carefully crafting input can deliberately cause these algorithms to have input causing them to run in the worst case running time. See, for example, “Denial of Service via Algorithmic Complexity Attacks”, Scott A. Crosby, Dan S. Wallach, Department of Computer Science, Rice University. These problems may exist in many software implementations of the regular expression matching library (regexp), where input data can cause the regexp matching to process in exponential running time. See, Tim Peters, [Python-Dev] Algorithmic Complexity Attack on Python dated Saturday May 31, 2003. Many pattern matching security systems make use of this library and are hence vulnerable to this style of algorithmic attack. Most systems that do not use regexp instead make use of variations of simplistic literal (exact) matching, and as a result can easily be fooled by an attacker crafting the attack to avoid the exact pattern being looked for. Preferably, the invention provides for wire speed pattern matching overcomes these deficiencies by pattern matching input data in real-time, while still allowing the full power of regular expressions in the pattern database. One or more of these benefits may be included in the embodiments described herein. These and other benefits are described throughout the present specification and more particularly below.

### BRIEF DESCRIPTION OF THE DRAWINGS

FIG. 1 depicts a typical network environment including of a Packet Based Network [100], a number of network systems [101], [102], [103] and a number of hosts connected to a Local Area Network (LAN) [104] according to an embodiment of the present invention.

FIG. 2 depicts an embodiment of the Integrated Circuit Apparatus of this invention on a rigid support member (such as a card) [201] according to an embodiment of the present invention.

FIG. 3 depicts a block diagram of an embodiment of the Integrated Circuit Apparatus [300] according to an embodiment of the present invention.

FIG. 4 depicts a functional block diagram of an embodiment of the Integrated Circuit Apparatus running in a look-aside (passive) mode of operation according to an embodiment of the present invention.

FIG. 5 depicts a functional diagram of the Integrated Circuit Apparatus running in a look-aside (passive) mode of operation with the inclusion of a Protocol Decoder [513] according to an embodiment of the present invention.

FIG. 6 depicts a functional diagram of an embodiment of the Integrated Circuit Apparatus running in a look-aside (passive) mode of operation with the inclusion of an Update module [614] according to an embodiment of the present invention.

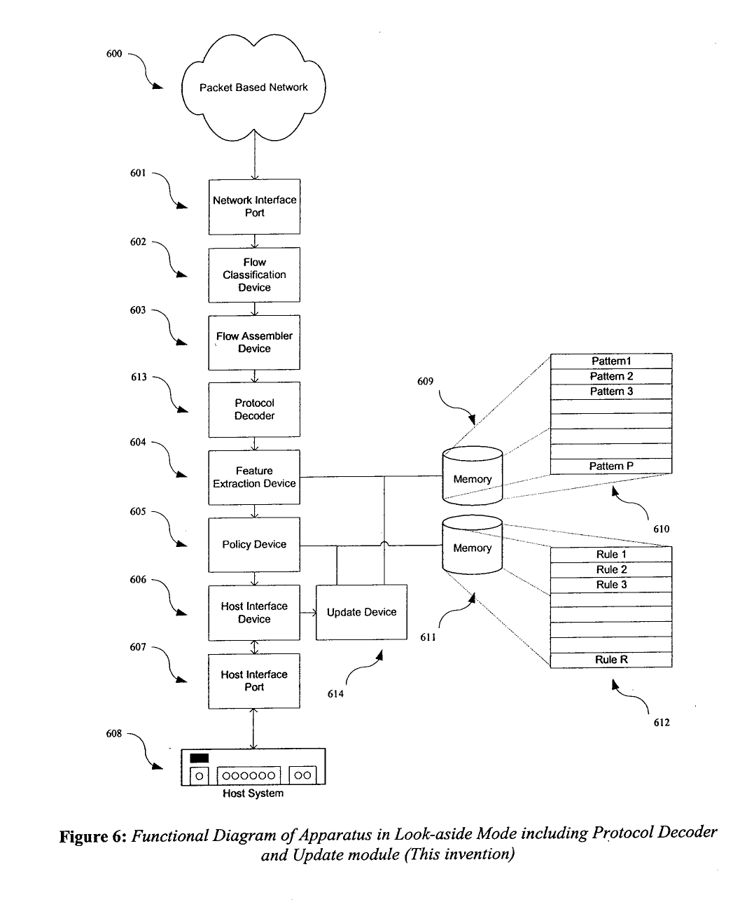

FIG. 7 illustrates that in one embodiment of the present invention multiple sets of patterns [701, 702, 703, 704], one for each application that is executing on the Apparatus, will be present in the Memory [700] of the Apparatus according to an embodiment of the present invention.

FIG. 8 is a flowchart of several of the processes running according to an embodiment of the present invention.

FIG. 9 depicts a flow classification process according to an embodiment of the present invention.

FIG. 10 depicts a functional block diagram of the present invention including the configurable insertion of flexible Stream Processor Blocks [1005] between each of the functional units [1000, 1001, 1002, 1003, 1004] according to an embodiment of the present invention.

FIG. 11 depicts an example taxonomy of Stream Processors according to an embodiment of the present invention.

FIG. 12 depicts an example representation of a plurality of patterns by a Regular Language and method for matching against compressed representation of the Regular Language according to an embodiment of the present invention.

FIG. 13 is a flowchart for converting an existing network system into an accelerated signature based network system according to an embodiment of the present invention.

### DETAILED DESCRIPTION OF THE INVENTION

According to the present invention, techniques for computer networking security applications are provided. More particularly, the invention includes an integrated circuit implementation of an apparatus for signature based network applications acting upon network packets and stream data at wire-speed. According to a specific embodiment, the invention includes an apparatus and method for high throughput flow classification of packets into network streams, packet reassembly of such streams (where desired), filtering and pre-processing of such streams (including protocol decoding where desired), pattern matching on header and payload content of such streams, and action execution based upon rule-based policy for multiple network applications, simultaneously at wire speed. Merely by way of example, the invention has been applied to networking devices, which are been distributed throughout local, wide area, and world wide area networks.

In a specific embodiment, the invention comprises an apparatus and method for performing pattern matching for network applications using specialized hardware. This present architecture allows the implementation of high throughput signature based network applications on packet based networks up to wire speed. The novel architecture specifically includes hardware support for pattern matching networking and security operations. This architecture is suited to high performance security systems based upon signature matching. These systems include Intrusion Detection Systems, Intrusion Prevention Systems, Antivirus Gateways, Email Scanning Gateways, Content Filtering Systems, Anti-spam Systems, Content Protection Systems, Bandwidth/Quality of Service Management, Content Monitoring Systems, Network Monitoring Systems, and many others. Another novel aspect of the invention is that the apparatus is adapted to couple to a variety of network systems including Firewalls, Network Appliances, Security Appliances, Servers and other Network Equipment, which have been described in more detail below.

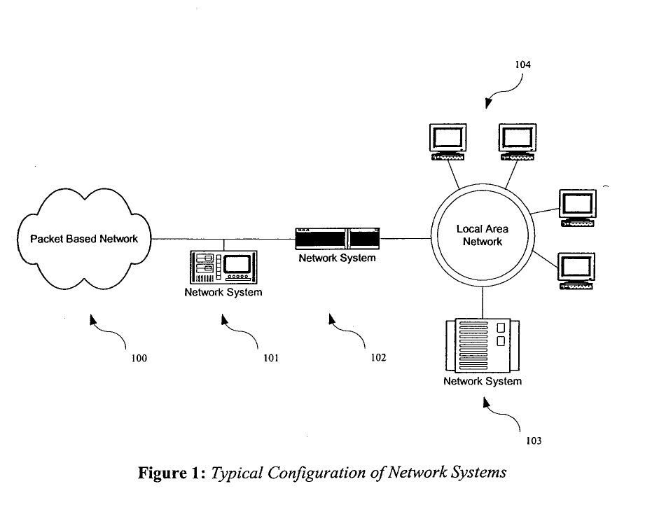

FIG. 1 depicts several examples of network systems which could be coupled to different embodiments of the apparatus. These examples are merely illustrative and should not limit the scope of the claims herein. One of ordinary skill in the art would recognize many variations, alternatives, and modifications. These examples include a look-aside network system at [101], an inline network system at [102] and a network server at [103], and possibly other elements. In this example, the network systems has a Look-aside Gateway Monitoring Device (e.g. network monitor or Intrusion Detection System) [101], a Gateway System (e.g. Router, Firewall or Switch) [102] connecting the LAN to the Packet Based Network [100] and a Host System (e.g. Workstation, Fileserver or Mail Server) [103] connected to the LAN (Communication is achieved between each of the network systems and other systems on both the LAN and Packet Based Network, through a variety of network protocols). At a low level, this data is broken into a series of segments known as packets. These packets are then routed independently across the network from source to destination, and as a result may take different paths and arrive out of order. The packets are then reassembled at the destination to recreate the original data stream. Further details of the present apparatus can be found throughout the present specification and more particularly below.

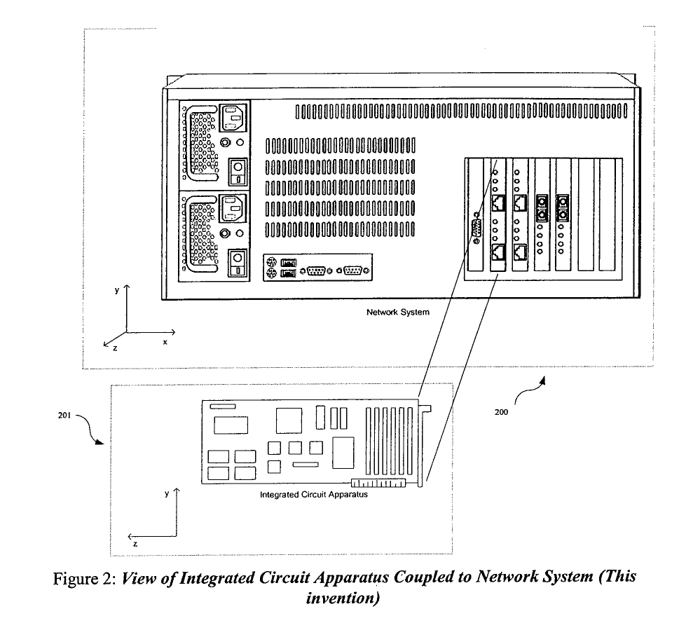

The apparatus [201] is shown in FIG. 2. This figure is merely an example, which should not unduly limit the scope of the claims herein. One of ordinary skill in the art would recognizes many variations, modifications, and alternatives. This apparatus may be coupled to a network system [200] through a connector region. Embodiments of the connector region which connect to the Host System include PCI and Compact-PCI standards which define the electrical and mechanical interfaces. The rigid support member has a selected width and selected length, being adapted to couple into a network system [200] such as network appliance, server or network node. Preferably, the rigid support member is suitable to server as a substrate (e.g., printed circuit board, silicon substrate, integrated circuit package) for a number of integrated circuit devices and other hardware, which will be used to implement an embodiment of the present invention. The rigid support member also includes a common bus, which can be coupled to any conventional network appliance, server, or network node.

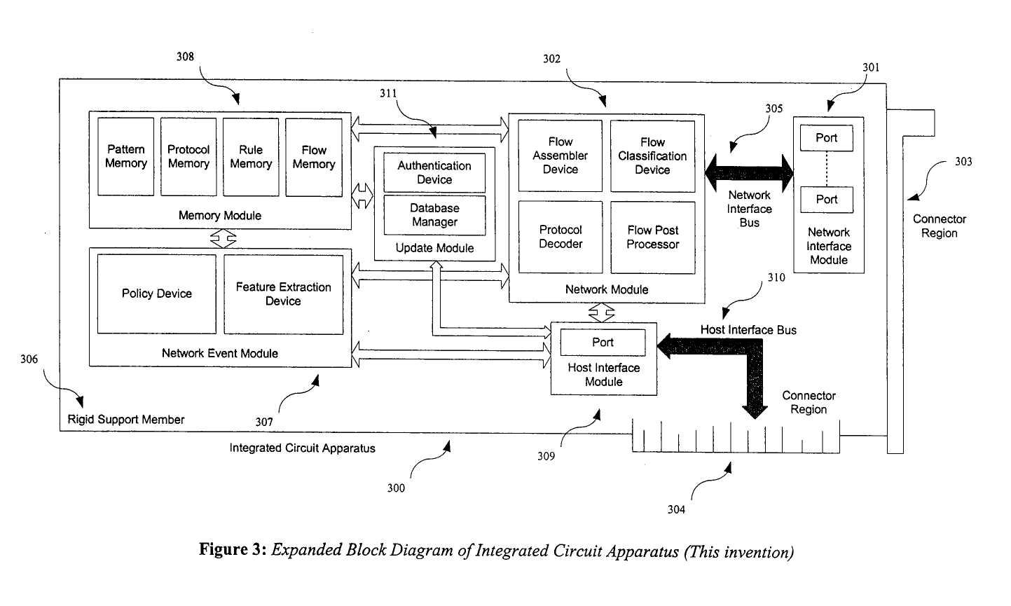

The apparatus includes a number of modules for performing high throughput analysis (e.g., wire speed) on network traffic as shown in FIG. 3. This figure is merely an example, which should not unduly limit the scope of the claims herein. One of ordinary skill in the art would recognizes many variations, modifications, and alternatives. Signals are received from the ingress network port within the Network Interface Module [301] according to the physical transmission medium (e.g. optical, electrical). Data is extracted from these signals in the form of bits. This data is passed to the Network Module [302] over the Network Interface Bus [301] (These bits then undergo a number of network preprocessing functions in order to extract the relevant data content). The data is packed into packets before being classified into a flow by the Flow Classification Device. The packet is then placed in Flow Memory (within the Memory Module [308]) until the Flow Assembler Device uses the packet to reconstruct a flow. The flow is then decoded according to pre-defined protocols (e.g. by the Protocol Decoder), filters and preprocessors to produce data content streams. Each embodiment of the present invention is capable of handling multiple data content streams, the extent of the present invention's multi stream capability is determined, in part, by the devices associated with the Network Module [302]. The present invention is further capable of operating simultaneously operating on one or more data content streams and on bidirectional data content streams. Reconstructed data content streams can be further processed using a range of flow post-processors or stream processors. In some embodiments, multiple stream processing blocks are disposed in the network module. In some embodiments, the functionality for each of the stream processors is programmable through software. Stream processor functions include, a null stream processor configured to generate an output sequence of data that is identical to an input sequence of data, a decompression processor configured to generate a typically larger than an input sequence of data by perform a decompression function on the input sequence of data, a decoder configured to produce an output sequence of data by decoding an input sequence of data according to type or structure, a decryption processor configured to produce an output sequence of data by decrypting an input sequence of data according to its encryption method, a digest generator configured to produce and output sequence of data that includes a summary of the input sequence of data, a checksum processor/verifier configured to produce an output sequence of data that includes the checksum or result of verification of the input sequence of data, a cyclic redundancy checksum (CRC) processor/verifier configured to produce an output sequence of data that includes the CRC or result of verification of the input sequence of data, and a filter configured to produce an output sequence of data that forms a typically reduced filtered version of the input sequence of data. From these data content streams relevant features are extracted by the Network Event Module [307] (The feature extraction can be thought of, in one embodiment, as a pattern matching process with a database of signatures provided by Pattern Memory within the Memory Module). The extracted features then trigger a message to the Policy Device, which interprets these features according to policies and rules (as provided by the Rule Memory), generating events and actions which are communicated to the Host System [304] via the Host Interface Module [309] and Host Interface Bus [310].

The Host Interface Bus being a standard hardware bus (e.g. PCI) so that the Integrated Circuit Apparatus can easily be integrated with a wide range of existing network equipment. Also coupled to the apparatus is an Update Module [311], which is controlled either by the Host System or a remote device across the Packet Based Network (coupled to the Network Interface Port via the Connector Region [301]). The Update Module adapting to update any of the memories within the Memory Module, so as to provide updates to patterns, protocol definitions, rules and other device properties.

The apparatus connects to a Packet Based Network through the connector region [303]. One embodiment of this connector region is the RJ-45 connector for IEEE 802.X Ethernet. Alternatively, the network can include, among others, Synchronous Optical Network (SONET), Asynchronous Transfer Mode (ATM), and others. Packets are received from the Packet Based Network through this region by the Network Interface Module [301], which may include a number of ingress network ports. One embodiment of the Packet Based Network is an Internet Protocol (IP) network. The Network Interface Module handles the translation of incoming electrical or optical signals into digital bits, and assembles those bits into packets according to a predefined specification (e.g. in one embodiment the IEEE802 Ethernet specification). The Network Interface Module couples to a Network Module [302] via a Network Interface Bus [305]. The Network Interface Bus in several embodiments includes the UTOPIA, SPI-3 and CSIX bus standards.

The Network Module includes a number of devices which take these digital bits and perform network processing functions. The Network Module receives packets of data from the Network Interface Module and provides the Network Event Module [307] with decoded, contiguous streams of data. In one embodiment, the Network Module may be provided by a single Network Processing Unit (NPU), and in others by a combination of integrated circuits, such as an NPU and Classification Processor. The Network Module is coupled to a Memory Module [308], which provides memory for a variety of devices and databases as explained herein. The Network Module provides a Flow Classification Device, which is responsible for identifying an association between each incoming packet and a flow, where a flow is a predetermined sequence of packets from a source address to a destination network address. The Flow Classification device then identifies the flow queue within Flow Memory (provided by the Memory Module) on which to place the packet, according to this association. The Flow Classification Device is coupled to a Flow Assembler Device, which manages the flow queues on a per-flow basis for these incoming packets, and effectively reorders the packets, according to a predetermined specification. In one embodiment, this specification would be TCP/IP. The Flow Assembler may, in one embodiment, couple to a Protocol Decoder which in turn is coupled to Protocol Memory, provided by the Memory Module. The Protocol Memory contains a plurality of network protocol definitions, which are used by the Protocol Decoder to identify salient protocol features from the network flow. In one embodiment, examples of such features may be source and destination email addresses as part of an SMTP e-mail message.

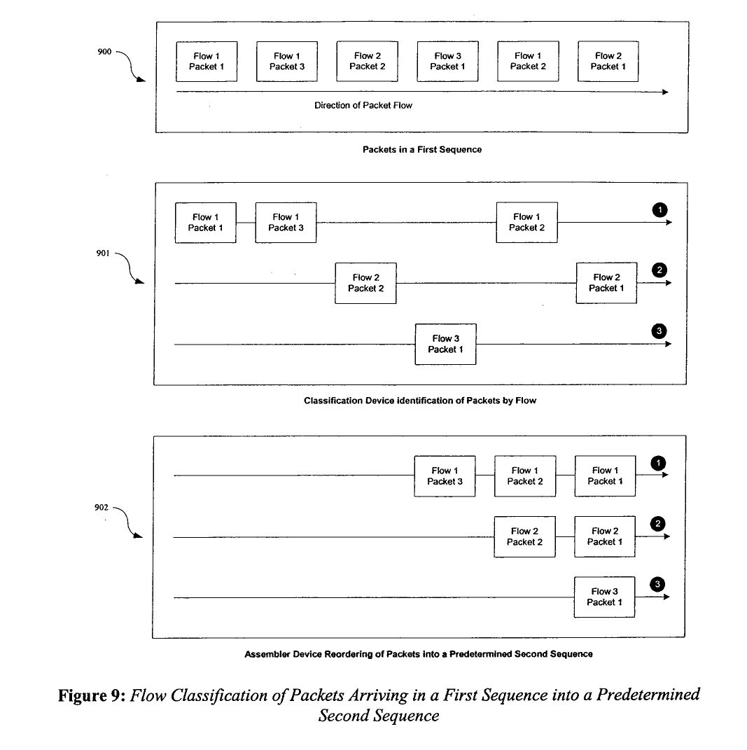

An embodiment of operation of the Network Module is illustrated in FIG. 9. As shown, FIG. 9 depicts the flow classification process for one embodiment of the present invention. In [900] packets from multiple flows arrive serially and possibly out of order. In the first step in flow classification is to determine on which flow queue to place each packet. In [902] each packet is placed in such a queue and the queue is sorted into correct sequence as determined by some pre-determined algorithm (e.g. sequence numbers in TCP/IP).

Referring back to FIG. 3, the Network Event Module [307] includes a number of devices, and analyses whole network streams to extract relevant features and then apply rules (or policy) to these features in order to signal, via events, the Host Interface Module [309]. In one embodiment, the Network Event Module is searching streams of data using pattern matching algorithms, and then analyzing these matches according to a rule set, in order to then notify the Host System of relevant network events. In one embodiment, the Network Event Module is provided by a Field Programmable Gate Array (FPGA). Incoming data streams from the Network Module are passed to the Feature Extraction Device, which identifies features of importance; a matchable representation of these features being stored within a Pattern Memory provided by the Memory Module.

In some embodiments of the invention, these patterns may be compiled representations of Regular Expressions, Deterministic Finite Automata, Berkeley Packet Filter expressions, Berkeley Packet Filter expression derivatives, or Approximate Signatures. In some embodiments, these databases of signatures may relate to a plurality of distinct applications executing simultaneously. In some embodiments, the database of signatures may comprise subsets of signatures, where a subset of signatures may be associated with a particular class of data content stream. Matched features are passed to a Policy Device, which analyses the features in relation to a database of rules, provided by the Rule Memory within the Memory Module. These rules are used to make higher level decisions based upon a predetermined schema, as provided by the applications related to these rules. In some embodiments, this allows aggregation of matched features (important in denial-of-service attack detection for Intrusion Detection Systems), or selective rule set enabling (e.g. enabling a rule subset based upon a network event or to provide pre-specified performance characteristics). In some embodiments, these databases of rules may relate to a plurality of separate applications executing simultaneously. In some embodiments, the database of rules may comprise subsets of rules, where a subset of rules may be associated with a particular class of data content stream. The Policy Device may, as a result of a rule, identify an action that needs to be performed. In some embodiments, such actions may include signaling the Host System via the Host Interface Module, signaling the Network Module to drop or modify (in the case that the apparatus is inline) a packet or plurality of packets, or triggering a counter or timer.

The Host Interface Module may be coupled to the Network Event Module and/or the Network Module. The Host Interface Module is responsible for the interfacing of the apparatus modules with the Host System. The Host Interface Module is coupled to the Host System via the Host Interface Bus [310], via the host component of the connector region

In one embodiment, this may be communications across a PCI bus, where the PCI standard defines the characteristics of the Host Interface Bus and Connector Region. In one embodiment, the Host Interface Module is provided by a separate ASIC or FPGA. Here, a example of a suitable FPGA or ASIC has interfaces to low latency RAM, at least 5,000 logic cells, multiple clocking domains, internal block RAM and a high speed data bus. As merely an example, the FPGA can be one such as the Virtex 2 Pro manufactured by Xilinx, Inc., but can be others. In another embodiment it may include an NPU, where the NPU has multiple processing units (e.g. micro-engines), an interface to multiple banks of low latency RAM and a high speed data bus. As merely an example, the NPU can be an IXP 2400 manufactured by Intel Corporation. Of course, one of ordinary skill in the art would recognize many other variations, alternatives, and modifications.

In one embodiment, the Host Interface Module will facilitate the signaling of the Host System by the Network Event Module according to triggered rules and/or actions. In one embodiment, the Host Interface Module is coupled to an Update Module [311], and facilitates communications between the Update Module and the Host System. In some embodiments, the Update Module is coupled to a network port and receive updates via the Packet Based Network. In some embodiments, the Update Module is operable concurrently with any other functional operation performed by the preset invention, including feature extraction, protocol decoding, and stream processing.

The Update Module is responsible for the management of the databases provided within the Memory Module. In embodiments of the invention, the Update Module is responsible for the updating of the patterns in the Pattern Memory, the protocol definitions in the Protocol Memory and the Rule databases in the Rule Memory. In certain embodiments, the Update Module may authenticate this process via the Authentication Device according to a pre-determined specification. The Authentication Device, in some embodiments, will do so in a cryptographically strong manner to maintain authenticity, integrity and confidentiality of the updates. In some embodiments the Authentication Device may provide hardware support for the acceleration of cryptographic primitives. In some embodiments the updates are provided by the Host System via the Host Interface Module, and in other embodiments, by a remote system on the Packet Based Network via the Network Module (possibly connected to the Apparatus on a separate Management Interface). In some embodiments, the Update Module may incorporate a Database Manager that is capable of updating one or more of the databases provided within the Memory Module. The Database Manager is capable of managing pattern sets, rule sets and protocol definition. In some embodiments, the Update Module may incorporate an Authentication Device that is capable of cryptographically authenticating any data communication involving the Update Module, including the update data.

In some embodiments the Integrated Circuit Apparatus may be operating in-line such that triggered rules make decisions to drop or modify packets, before passing such packets out on an egress network interface, being provided by the Network Interface Module. In such an embodiment, the Network Event Module will identify such a decision, and signal the Network Module to perform the operation in its Flow Post Processor.

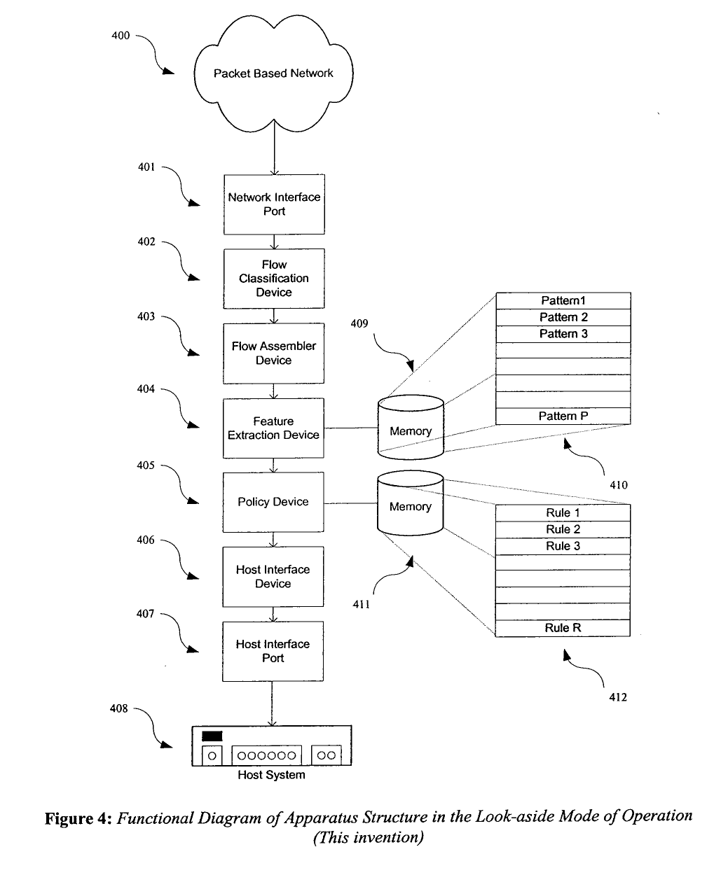

In FIGS. [4, 5, 6], different embodiments of the Integrated Circuit Apparatus are represented, showing the data flow from the Packet Based Network, through to the Host System. Referring to FIG. 4, the Integrated Circuit Apparatus executes network applications on packets arriving from the Packet Based Network [400]. The packets are first received via the Network Interface Port [401], where they are translated from physical signals (e.g. electrical, optical) into bits and arranged into packets of data. These packets of data are then passed to a Flow Classification Device [402] that associates each packet with a network flow. These packets are then assembled into flows by the Flow Assembler Device [403]. The Flow Assembler Device then passes data, in the form of reassembled flows, through to a Feature Extraction Device [404]. The Feature Extraction Device identifies patterns or signatures within these flows from a database of patterns [410] stored within a Pattern Memory [409], and signals successful matches to the Policy Device [305]. The Policy Device associates one or more matches with events according to a database of rules [412] stored in a Rule Memory [411], translating the matches into network events and associated actions. The Policy Device communicates to the Host System [406] messages about these events, actions and other state information via the Host Interface Device [407]. Depending upon the embodiment, the messages can include an access control list update message, an audit message, an event message, an alarm message, a status message, a query message, an update message, a management message, an error message, a warning message, any combination of these and the like. The Host Interface Device couples to the Host System through the Host Interface Port [407], which translates the message bits into physical signals suitable for transmission.

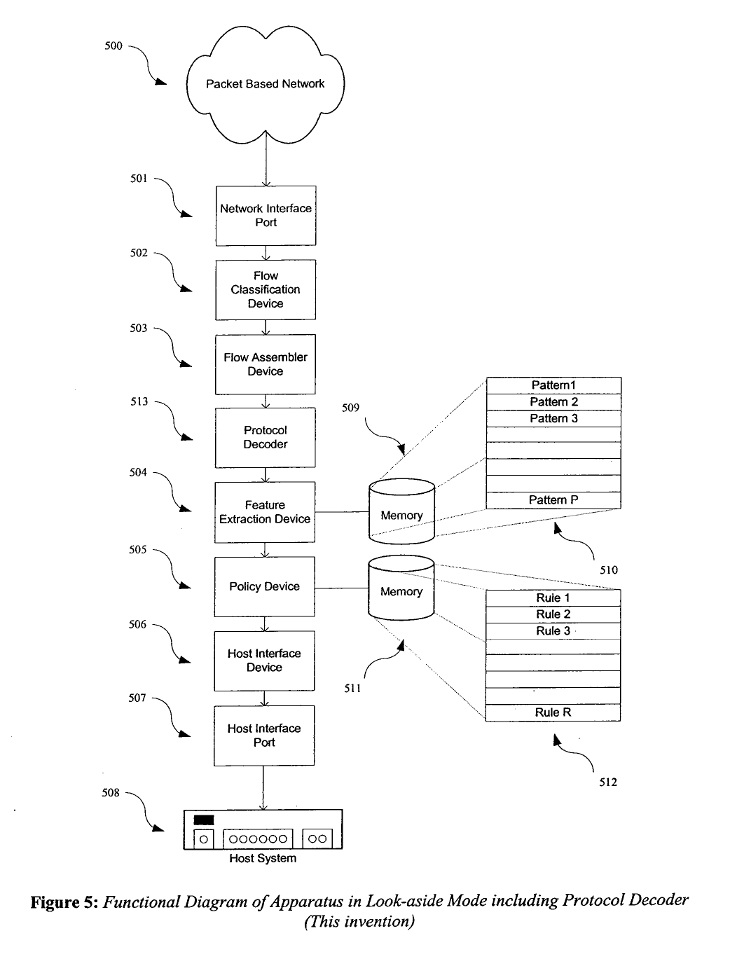

Referring to FIG. 5, the packets are received via the Network Interface Port [501], where they are translated from physical signals (e.g. electrical, optical) into bits and arranged into packets of data. These packets of data are then passed to a Flow Classification Device that associates each packet with a network flow. These packets are then assembled into flows by the Flow Assembler Device [503]. The Flow Assembler Device then passes data in the form of reassembled flows through to a Protocol Decoder, which parses the flows according to network protocol descriptions into protocol content flows. These protocol content flows are then passed to the Feature Extraction Device [504]. The Feature Extraction Device identifies patterns or signatures within these protocol content flows from a database of patterns [510] stored within a Pattern Memory [509], and signals successful matches to the Policy Device [505]. The Policy Device associates one or more matches with events according to a database of rules [512] stored in a Rule Memory [511], translating the matches into network events and associated network actions. The Policy Device communicates to the Host System [508] messages about these events, actions and other state information via the Host Interface Device [506]. The Host Interface Device couples to the Host System through the Host Interface Port [507], which translates the message bits into physical signals suitable for transmission. In some embodiments, a defragmentation module is coupled to one or more ingress network ports and to the Flow Classification Device. The defragmentation module is adapted to assemble one or more fragmented input packets into an unfragmentated output packet according to a predetermined specification. The defragmentation module then passes the assembled unfragmented output packet to the Protocol Decoder.

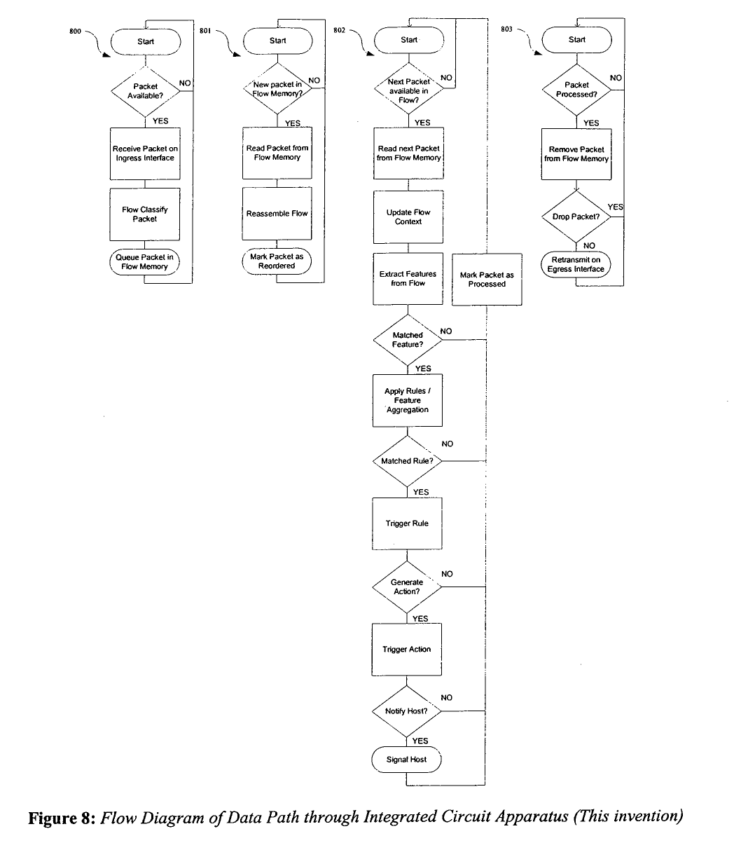

FIG. 8 shows logical operations within the apparatus in embodiments of the invention. A high level description of these operations is as follows: in one process [800], packets are received from an ingress network interface, classified as belonging to a flow and queued in Flow Memory. In a second process [801], packets are read from the Flow Memory, reassembled into a contiguous flow. In a third process [802], these reassembled flows are then analyzed for relevant features, the identification of which, desires a decision to be made, based upon a rule database, as to whether to trigger an action, notify the host and the like. In some embodiments, the Integrated Circuit Apparatus is operating in a flow through mode of operation. In this mode, a fourth process [803], takes packets that have been processed, and may drop them completely or modify them before they are transmitted on an egress network interface.

Diagram [800] shows the packet receipt process, which includes: waiting for a packet to become available on an ingress network interface port, receiving such packet, classifying the packet according to a flow, then placing the packet in Flow Memory. Diagram [801] shows another process that waits for such packets to be queued in Flow Memory, then reassembles such packets into flows before placing them on one of the Pattern queues. Diagram [802] depicts a further process which checks the pattern queues for ready data; then removes such data off the queue, updating the context of the device to that of the flow of the current data, extracting the features that are found from such a flow. If no features are found, then the process waits for the next available packet, otherwise it triggers any rules that may be associated with the triggered feature. If the rule is associated with an action, the process then triggers the associated action (e.g. flagging, the notification of the Host System, to drop or modify the packet). Should the host warrant notification by the rule, a message is then passed to the Host System with any relevant information (e.g. packet data or digests of such). [803] is a process which runs for some embodiments of the invention (when the apparatus is running in the “flow-through”, otherwise known as “active” or “inline”, mode of operation). In this case, the process waits for packets in the Flow Memory to be flagged as processed, it then removes the packet from the queue and either drops or retransmits the packet on the egress interface depending on the action being executed.

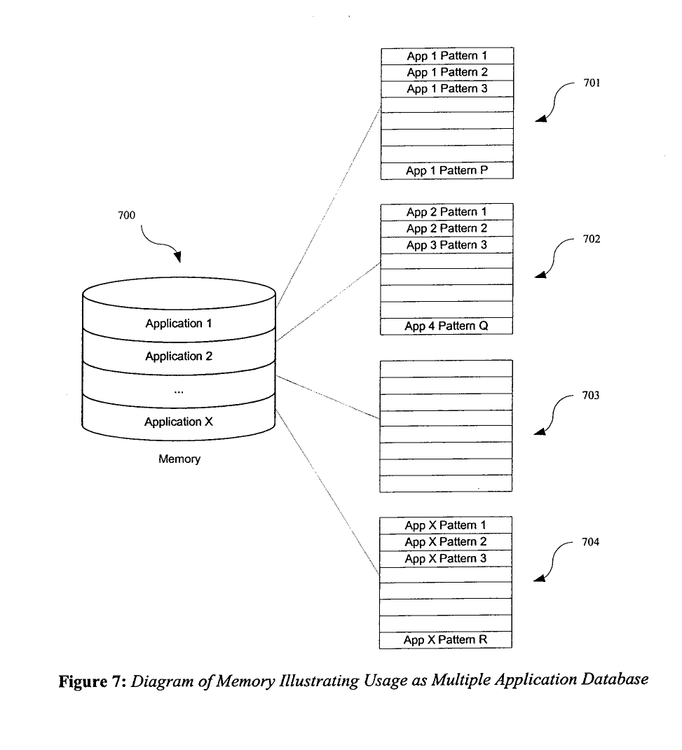

FIG. 7 illustrates that the Integrated Circuit Apparatus may have multiple procedures running simultaneously on network traffic. Likewise, each application may have its own rule definitions within rule memory. The operation of the modules within this device [600, 601, 602, 603, 604, 605, 606, 607, 608, 609, 610, 611, 612, 613] are the same as for FIG. 5, with the exception that the Host System [608] may, via the Host Interface Device [606], communicate to the Update Device updates of either of the pattern database, or the rule database. The Update Device controls the management of these updates within the memories [609, 611]. Alternately, the databases may be updated through a management protocol over the Packet Based Network [600] via the Network Interface Module. In such embodiments, each procedure may have its own pattern database in Pattern Memory, and rule database in Rule Memory. Such databases may not necessarily be stored within separate memory blocks in hardware form, and may instead be compact hardware representations within a single database.

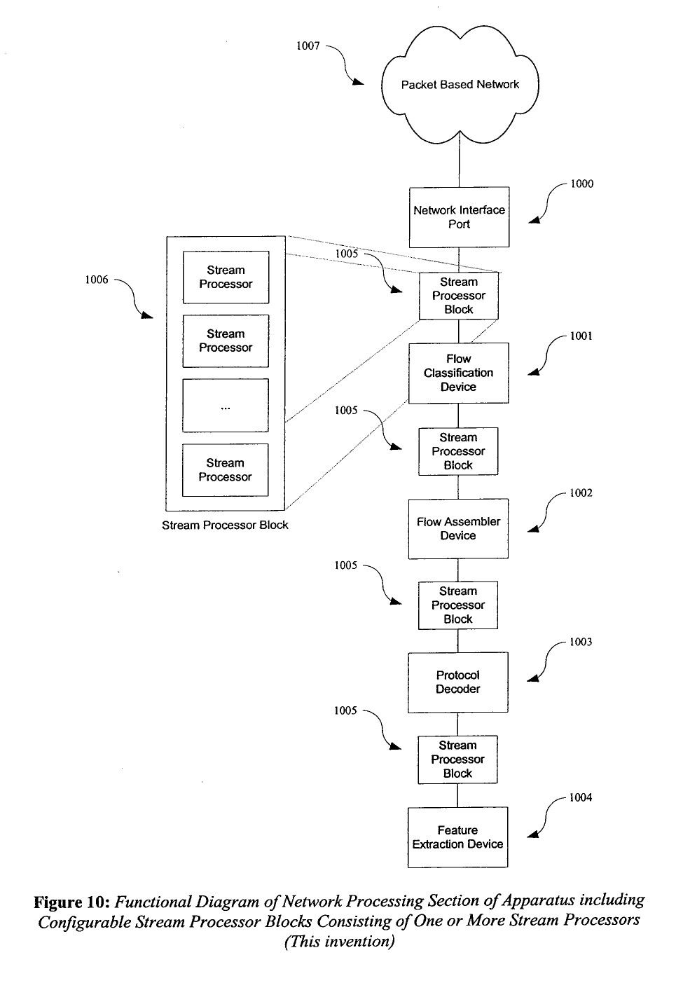

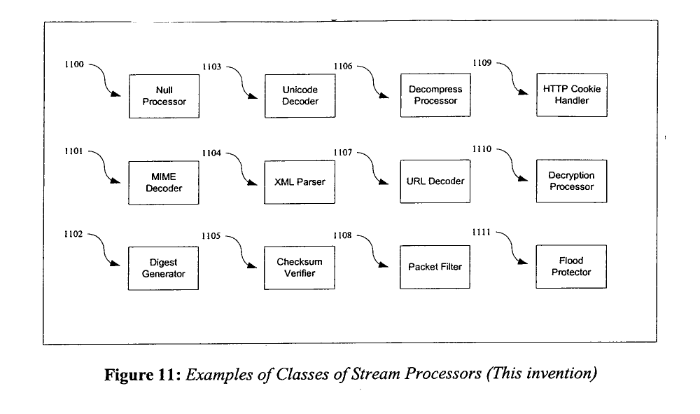

Some embodiments of the invention include Stream Processor Blocks [1005], which can contain several Stream Processors [1006], as shown in FIG. 10. Each Stream Processor Block may include one or more Stream Processors [1006]. The Stream Processors can be one or more in a series of algorithmic units that act upon a packet or stream of packets; several examples of the blocks that can be placed in [1006] are shown in FIG. 11.

FIG. 11 depicts an example taxonomy of Stream Processors including a Null Processor [1100] which copies data input directly to output with no modification, a MIME Decoder [1101] which decodes MIME encoded data, a Digest Generator [1102] which takes a data stream and outputs some subset or digest of such data (e.g. packet headers), a Unicode Decoder [1103] which decodes Unicode encoded data, an XML Parser [1104] which parses and decodes XML encoded data according to some predetermined specification, a Checksum Verifier [1105] which performs a checksum operation of input data according to some predetermined specification (e.g. CRC-32), a Decompression Processor [1106] which decompresses input data streams according to some predetermined algorithm (e.g. zip), a URL Decoder [1107] which decodes an HTTP encoded URL, a Packet Filter [1108] which filters input data according to some predetermined specification (e.g. BPF), an HTTP Cookie Handler [1109] which parses input data according to the HTML or related specification and decodes a Cookie within the stream and then performs some predetermined function, a Decryption Processor [1110] which decrypts input data according to some predetermined specification (e.g. DES, AES), and a Flood Protector [1111] which processes input data according to some predetermined algorithm in order to recognize and/or filter flooding attacks.

As shown, these blocks allow additional computation to be done before the Feature Extraction Device acts upon the data. In one embodiment of the invention, a Decompress Processor might act upon a flow to produce a new set of flow bytes which can now be examined. Because these blocks can be serially configured between other logical modules and devices of the apparatus, a decryption block could be followed by a decompression block. Methods according to alternative embodiments of the present invention are provided throughout the present specification and more particularly below.

A method for performing high throughput pattern matching according to the present invention is outlined as follows.

1. Provide a plurality of patterns defined by a regular language;

2. Implement the regular language as a finite automata which includes a transition table to describe the transition function of the finite automata;

3. Express the transition table in compressed form such the transition function of the finite automata is able to be computed from the compressed form in a predetermined (e.g., maximum) time that is constant with respect to the size of the compressed form;

4. Store the compressed form;

5. Match patterns by computing the transition function from the current state of the finite automata and incoming data; and

6. Perform other process steps, as desired.

As shown, the above sequence of steps provides a method for high throughput pattern matching using a Regular language. According to a specific embodiment, the method performs high throughput pattern matching using, for example, the hardware and software described herein. That is, the pattern matching process and storage of patterns can be implemented in the hardware and software features described in one or more of the figures and descriptions. The high throughput pattern matching operation is performed using one or more of a plurality of patterns. The patterns are preferably defined by a regular language; which has been implemented as a finite automaton. The finite automaton includes a transition table representation of the regular language. The transition table describes a transition function for the finite automaton. The transition table is adapted to be stored in a compressed form, which is adapted such that the transition function of the finite automaton is able to be computed from the compressed form in a predetermined time (e.g., maximum time) that is constant with respect to the size of the compressed form. Further details of the present method can be found through out the present specification and more particularly below.

In one embodiment of the invention, the computation of the next state of the finite automata from the current state and incoming data is independent of the size of the compressed transition table, and is constant. In order that high throughput be achieved, this computation should take less than 40 nanoseconds. In another embodiment of the invention, the compressed transition table should occupy less than one-fifth the space of the original transition table. This can be achieved using compression technologies such as those described in U.S. Provisional Patent Application 60/473,373 filed May 23, 2003, commonly assigned, and titled “Apparatus and Method for Large Hardware Finite State Machine with Embedded Equivalence”, and U.S. Provisional Patent Application 60/454,398 filed on Mar. 12, 2003, commonly assigned, and titled “Apparatus and Method for Memory Efficient Programmable Pattern Matching Finite State Machine Hardware”. Alternatively, other similar technologies, obvious to those trained in the art, to reduce the size of the memory footprint for the transition tables can also be used. In one embodiment, the compressed transition table has a smaller memory footprint than an uncompressed transition table for a minimal deterministic finite automata (DFA), where the minimal DFA being a DFA of the one or more of the plurality of patterns and having no more states than any other possible DFA representation of the one or more of the plurality of patterns. In one embodiment, the compressed transition table has a compression ratio of greater than 5:1, the compression ratio being the ratio of memory desired by the uncompressed transition table compared to the compressed transition table. In another embodiment, the compressed transition table has a compression ratio of greater than 5:1, the compression ratio being the ratio of memory desired by the uncompressed transition table compared to the compressed transition table, and where the transition function is computed in less than 40 nanoseconds. In another embodiment, the compressed transition table is adapted such that the transition function of the finite automaton is computed from the compressed transition table in a maximum time that is constant with respect to the size of the compressed transition table, where the transition function supports a sustained data rate of greater than or equal to 1.6 gigabits per second.

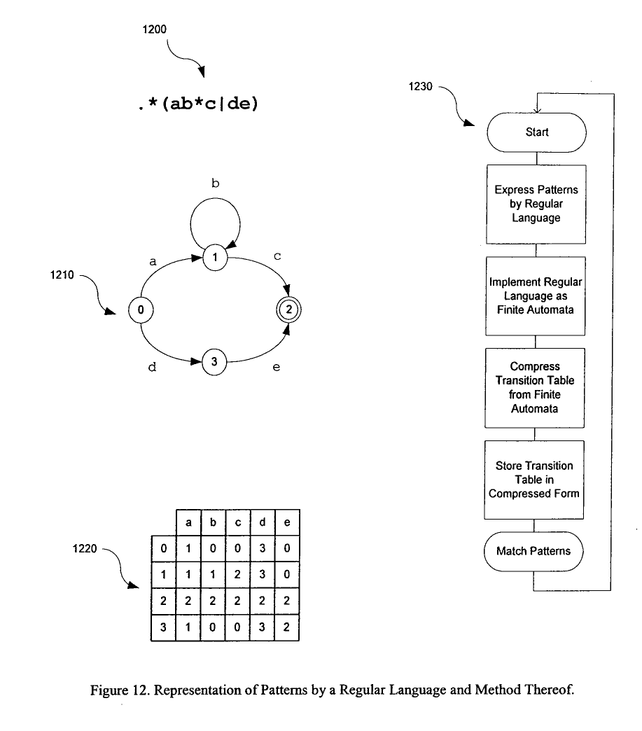

Further details of the present method are provided according to FIG. 12. Merely by way of example, [1200] shows the Regular Language for expressing two example patterns. The first pattern represents the character “a” followed zero or more “b” characters, followed by the character “c”. The second pattern represents the literal string “de”. The patterns are combined by the “|” symbol which indicates alternation, as familiar to those trained in the art. The “.*” at the front of the Regular Language expression indicates that it can match the patterns anywhere within given data. The finite automata for implementing the Regular Language defined by [1200] is depicted in [1210]. Only the main transitions are shown for clarity. Those trained in the art will recognize the finite automata [1210] as being an implementation of the patterns defined by the Regular Language [1200]. The transition table [1220] expression of the finite automata fully defines all transitions within the automata. This transition table should be compressed in order to conserve memory, and used for matching the patterns against incoming data. The method for performing high throughput pattern matching according to the present invention is outlined in flowchart [1230]. As shown, the flow chart includes processes of start (e.g., initiation), express patterns by regular expression, implement regular language as finite automata, compress transition table from finite automata, store (e.g., memory) transition table in compressed form, and perform patterning matching process. Depending upon the embodiment, certain steps may be combined or even separated further. Additionally, one or more steps may be inserted or even exchanged for others. Depending upon the embodiment, the functionality can be performed in software, hardware, or a combination of hardware and software without departing from the scope of the claims herein.

A method for converting a network system into an accelerated signature based network system according to the present invention is outlined as follows.

1. Provide a network system, e.g., conventional network, IP based, network;

2. Provide an integrated circuit apparatus for high throughput signature based network applications;

3. Connect the integrated circuit apparatus to the network system, e.g., a firewall, a network management system, an intrusion prevention system, a router, a network switch, a logging system, a network appliance, a security system; an anti-virus system, an anti-spam system, an intrusion detection system, a content filtering system, a network monitoring system, a file server, a mail server, a web server, a proxy server, and a storage area network system;

4. Transfer onto the network system selected driver software which facilitates communications between the network system and the apparatus;

5. Initialize the apparatus via a signal generated by the network system; and

6. Perform other steps, as desired.

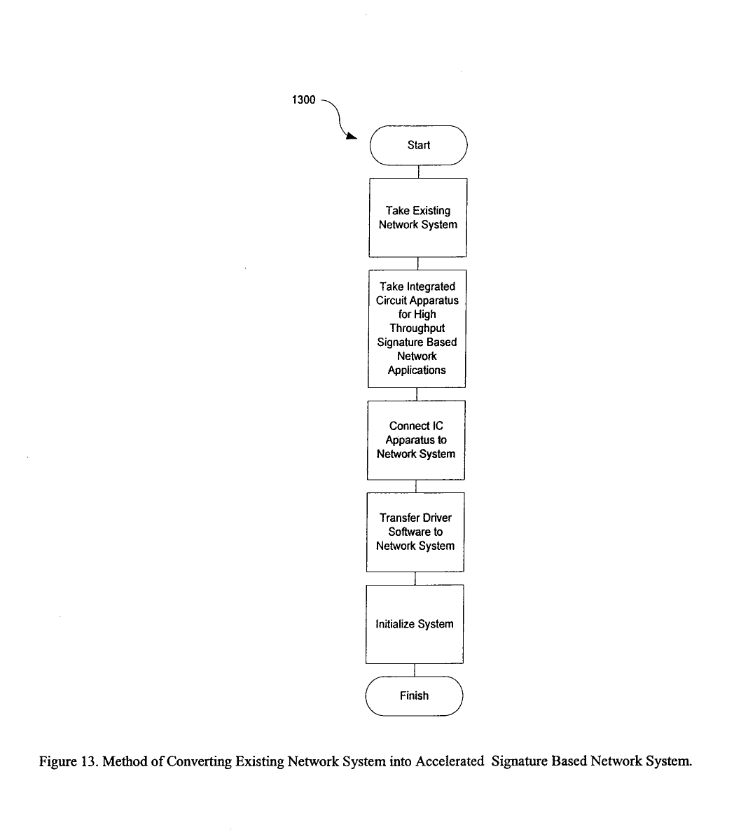

In one embodiment of the invention, the method involves replacing one or more existing network interface cards in the network system with the apparatus. As shown, the present invention provides a method for converting a network system into an accelerated signature based network system. Further details of the present method are provided according to FIG. 13. This diagram is merely an example, which should not unduly limit the scope of the claims herein.

Preferably, the method includes providing a network system. The network system has one or more input ports. A host processor is coupled to the one or more input ports. A host memory is coupled to the host processor. A host interface bus is coupled to the host processor and a host connector is coupled to the host interface bus. The method also includes providing an integrated circuit apparatus for high throughput pattern matching for network applications. As merely an example, the present apparatus described herein can be used, as well as others. The method also includes connecting the host interface connector region of the integrated circuit apparatus with the host connector on the network system to mechanically and electrically couple the host interface bus of the network system to the host interface bus of the integrated circuit apparatus. The method also transfers selected driver software to the network system. Preferably, the driver software is configured to facilitate communication between the integrated circuit apparatus and the network system via the host interface bus. The method also initializes the integrated circuit apparatus via the driver software. Once the apparatus has been integrated into the networking system, various methods can be performed. An example of such a method is provided in more detail below and well as other portions of the present specification.

A method for signature based pattern recognition using an integrated circuit apparatus according to the present invention is outlined as follows.

1. Provide an integrated circuit apparatus for high throughput signature based network application;

2. Transfer information from a packet based network to a network interface port on the apparatus;

3. Transfer the information from the network interface port across the network interface bus on the apparatus;

4. Receive the information from the network interface bus at a processing unit;

5. Identify an association between one or more packets and a flow from the information using the processing unit;

6. Place the one or more packets into one or more respective flows, reordering out of order packets;

7. Determine if the one or more packets for the one or more respective flows is associated with a pattern stored within the database of patterns, whereupon the determination is performed using a memory having a random access time of less than 8 nanoseconds;

8. Send a signal to the policy engine if a match occurs.

As shown, the present invention includes a method for signature based pattern recognition using an integrated circuit apparatus. The method includes providing an integrated circuit apparatus for high throughput pattern matching for network applications. The apparatus can be the one described herein, but can also be others depending upon the embodiment. The apparatus is integrated into a pre-existing network via common interface bus without substantial hardware modifications. Here, the apparatus is merely inserted into the connector for the common interface bus for preferred embodiments. The method then transfers information from a packet based network to a network interface port through the connector and transfers the information from the network interface port through a network interface bus also through the connector. The method receives information from the network interface bus at a processing unit and identifies an association between one or more packets and a flow from the information using the processing unit. Preferably, the method reorders the one or more packets into one or more respective flows and determines if the one or more packets for the one or more respective flows is associated with a signature based pattern stored in memory through a memory bus coupled to the processing unit. The determining occurs using the memory having a random access time of less than 8 nanoseconds in preferred embodiments. The method initiates a signal to a policy engine on the apparatus if an association occurs. Once the apparatus has been integrated into the networking system, various methods can be performed. An example of such a method is provided in more detail below as well as other portions of the present specification. In one embodiment of the invention, the method for signature based pattern recognition further requires the decoding of reordered packets according to specific protocols. The decoding is performed by the processing unit. Some protocols, such as [1104] XML Parsing are shown in FIG. 11.

The previous description of the specific embodiments are provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein. For example, the functionality above may be combined or further separated, depending upon the embodiment. Certain features may also be added or removed. Additionally, the particular order of the features recited is not specifically required in certain embodiments, although may be important in others. The sequence of processes can be carried out in computer code and/or hardware depending upon the embodiment. Of course, one of ordinary skill in the art would recognize many other variations, modifications, and alternatives.

Although the foregoing invention has been described in some detail for purposes of clarity and understanding, those skilled in the art will appreciate that various adaptations and modifications of the just-described preferred embodiments can be configured without departing from the scope and spirit of the invention. For example, other pattern matching operations may be used, different network and system interfaces may be used, or modifications may be made to the packet processing procedure. Moreover, the described network processing and pattern matching features of this invention may be implemented within separate integrated circuits, or in a single integrated circuit. The present system can also be applied to a variety of applications including intrusion detection, intrusion prevention, firewalling, content filtering, access control, antivirus, network monitoring, traffic filtering, spam filtering, content classification, application-level switching, bandwidth/quality of service management, surveillance, and XML web services, among others. Therefore, the described embodiments should not be limited to the details given herein, but should be defined by the following claims and their full scope of equivalents.

What is claimed is:

1. An integrated circuit apparatus for high throughput pattern matching in network applications, the apparatus comprising:
a rigid support member comprising a connector region, the connector region including a network connection region and a host connection region, the rigid support member having a selected width and a selected length, the selected width and selected length being adapted to couple via the connector region into a network system;
one or more hardware modules disposed onto and coupled to the rigid support member, the one or more hardware modules including:
a network interface module coupled to the rigid support member; the network interface module including one or more network interface ports; the one or more network interface ports being coupled via the connector region to a packet based network; the one or more network interface ports containing one or more ingress network ports;
a network interface bus coupled to the rigid support member, the network interface bus being adapted to interface the network interface module;
a network module coupled to the rigid support member, the network module being coupled to the network interface bus;
a network event module coupled to the rigid support member, the network event module being coupled to the network module;
a memory module coupled to the rigid support member, the memory module being coupled to the network event module and the network module, the memory module including a pattern memory, the pattern memory being associated with a plurality of pre-stored patterns;
a host interface module coupled to the rigid support member, the host interface module being coupled to at least the network event module or at least the network module or both the network event module and the network module; and
a host interface bus coupled to the rigid support member, the host interface bus being coupled to the host interface module, the host interface bus being capable of connecting to the host system via the connector region.

2. Apparatus of claim 1 wherein the network module, the network interface module, the network event module and the host interface module are provided on a single integrated circuit.

3. Apparatus of claim 2 wherein the single integrated circuit is a network processing unit (NPU).

4. Apparatus of claim 2 wherein the single integrated circuit is a reconfigurable logic circuit.

5. Apparatus of claim 2 wherein the single integrated circuit is an application specific integrated circuit.

6. Apparatus of claim 4 wherein the reconfigurable logic circuit is a field programmable gate array (FPGA).

7. Apparatus of claim 1 wherein the network interface module comprises a media access control layer and a physical access layer, the network interface module being associated with at least one of a plurality of networks including Ethernet (IEEE 802.X) network, SONET, and ATM.

8. Apparatus of claim 1 wherein the integrated circuit apparatus is a multi-stream integrated circuit apparatus, the multi-stream integrated circuit apparatus operates on one or more streams of data simultaneously.

9. Apparatus of claim 1 wherein the network interfaces are characterized by a specified data rate equal to or greater than 10,000,000 bits per second.

10. Apparatus of claim 1 wherein the rigid support member is selected form at least a printed circuited board (PCB), a silicon substrate, and integrated circuit package.

11. Apparatus of claim 1 where in the network module comprises:
a flow classification device, the flow classification device being coupled to the one or more ingress network ports; the flow classification device being capable of identifying one or more packets; the one or more packets being in a first sequence; and identifying a flow out of a plurality of flows to which the one or more packets belong; and
a flow assembler device, the flow assembler device being coupled to the flow classification device; the flow assembler device being capable of reordering the one or more packets into a second sequence; the second sequence being a predetermined sequence as determined by the flow.

12. Apparatus of claim 11 wherein the network module additionally comprises a protocol decoder; the protocol decoder being coupled to the flow assembler device; the protocol decoder being adapted to identify the one or more packets in the predetermined sequence and also adapted to process the one or more of the packets in the predetermined sequence to provide payload information from the one or more packets according to one or more protocol definitions; the one or more protocol definitions being provided from a protocol memory; the protocol memory being provided by the memory module.

13. Apparatus of claim 12 wherein the network module additionally comprises a flow post-processor; the flow post-processor being coupled to the network event module; the flow post-processor identifying an association between one or more of a plurality of packets; flow post-processor being adapted to select, using this association, from one or more of a plurality of flow post-processing algorithms; the one or more flow post-processing algorithms being performed on one or more of a plurality of packets; the flow post-processor being coupled to the network interface module; the network interface module including one or more egress network interface ports; the one or more egress network interface ports being coupled via the connector region to a packet based network.

14. Apparatus of claim 1 wherein the packet based network is an internet protocol (IP) network.

15. Apparatus of claim 1 wherein the packet based network is asynchronous transfer mode (ATM) network.

16. Apparatus of claim 1 wherein the high throughput is greater than 100,000,000 bits per second.

17. Apparatus of claim 13 further comprising an update module coupled to the rigid support member, the update module being adapted to update the plurality of pre-stored patterns and the plurality of pre-stored rules; the updated patterns and rules including at least one new pattern or at least one new rule.

18. Apparatus of claim 17 wherein the update module is operable while the pattern matching engine is operable.

19. Apparatus of claim 17 wherein the update module being adapted to update the plurality of pre-stored protocol definitions; the updated protocol definitions including at least one new protocol definition.

20. Apparatus of claim 19 wherein the update module is operable while the protocol decoder is operable.

21. Apparatus of claim 1 wherein
the memory module additionally comprises:
a feature memory; the feature memory being associated with a plurality of pre-stored features;
a rule memory; the rule memory being associated with a plurality of pre-stored rules;
the network event module comprises:
a feature extraction device; the feature extraction device being coupled to the network module and the memory module; the feature extraction device being capable of identifying a feature association according to a feature extraction algorithm; the feature extraction algorithm identifying a feature association based upon examination of one or more packets according to some pre-determined functionality; the feature association identifying one or more of a plurality of pre-stored features; the pre-stored features being stored in a feature memory;
a policy device, the policy device being coupled to the feature extraction device and the memory module; the policy device identifying a rule association based upon the feature association identified by the feature extraction device according to a policy algorithm, the policy algorithm identifying the rule association by examining the feature association according to some pre-determined functionality, the rule association identifying one or more of a plurality of pre-stored rules; the pre-stored rules being stored in a rule memory.

22. Apparatus of claim 21 wherein the feature extraction algorithm is a pattern matching operation; the pre-stored features are one or more of a plurality of pre-stored patterns; the pre-stored patterns are provided by a pattern memory; the pattern memory being provided by the memory module.

23. Apparatus of claim 22 wherein the pre-stored patterns include one or more regular expressions.

24. Apparatus of claim 22 wherein the pre-stored patterns include one or more n-gram expressions, the n-gram expression being a tuple of symbols.

25. Apparatus of claim 22 wherein the feature extraction algorithm is an approximate pattern matching process for at least one or more of the predetermined stored patterns.

26. Apparatus of claim 25 wherein the approximate pattern matching process is performed on a file selected from at least text files of data, text streams of data, binary files of data, binary streams of data, audio streams of data, audio files of data, video streams of data, video files of data, multimedia streams of data, and multimedia files of data.

27. Apparatus of claim 25 wherein the measure of approximation in the approximate pattern matching process is an edit distance; the edit distance is the number of insertions, deletions or substitutions desired to exactly match the pattern.

28. Apparatus of claim 25 wherein the measure of approximation in the approximate pattern matching process is related to human perception.

29. Apparatus of claim 21 wherein the identified rule association signals an action, the action changing the state of the apparatus.

30. Apparatus of claim 29 wherein the action enables one or more of a selection of pre-determined rules in rule memory, the enabling being for a pre-determined quantity of time.

31. Apparatus of claim 1 wherein an update module is coupled to the rigid support member, the update module coupled to the memory module, the update module providing a database manager, the database manager configured to be capable of updating one or more of a plurality of memories within the memory module.

32. Apparatus of claim 31 wherein the update module further comprises an authentication device; the authentication device being adapted to provide cryptographic authentication of the updates being provided to the update module.

33. Apparatus of claim 22 wherein the pre-stored patterns include one or more temporal regular expressions.

34. Apparatus of claim 1 wherein the network interface bus is selected form at least UTOPIA, SPI-3; and CSIX.

35. Apparatus of claim 21 wherein one or more of the pre-stored rules is related to a counting component; the counting component including a counter and a threshold; the threshold being compared against the value of the counter.

36. Apparatus of claim 21 wherein one or more of the pre-stored rules is related to a temporal component.

37. Apparatus of claim 36 wherein the temporal component is selected from at least a quantity of time, an absolute time, infinity, and zero.

38. Apparatus of claim 37 wherein the temporal component is related to a counting component; the counting component including a counter and a threshold; the threshold being compared to the counter; the combined temporal and counter components defining a rate of change.

39. Apparatus of claim 21 wherein the policy device is coupled to the host interface device, the policy device signaling the host interface device with the identified rule association.

40. Apparatus of claim 1 wherein memory module includes one or more memory devices selected from at least random access memories (RAM), content addressable memories (CAM), including ternary content addressable memories (TCAM), and a combination of one or more RAMs and one or more CAMs.

41. Apparatus of claim 1 wherein one or more network interface ports also include one or more egress network ports; the egress network ports being coupled to the packet based network.

42. Apparatus of claim 41 wherein one or more of the egress network interface ports is a response port; the response port being used to facilitate communications to a remote network system via a signal.

43. Apparatus of claim 42 wherein the remote network system is selected from at least firewall, network management system, intrusion prevention system, router, network switch, and logging system.

44. Apparatus of claim 42 wherein the signal may include one or more of a plurality of messages.

45. Apparatus of claim 44 wherein the one or more of a plurality of messages includes one or more messages selected from at least:
an access control list update message;
an audit message;
an event message;
an alarm message;
a status message;
a query message;
an update message;
a management message;
an error message; and
a warning message.

46. Apparatus of claim 42 wherein the signal is related to a network event; the network event being pre-determined event of interest on the network detected by the network event module.

47. Apparatus of claim 42 wherein the signal is related to the policy device output.

48. Apparatus of claim 1 wherein one or more of the ingress network ports is a management port.

49. Apparatus of claim 48 wherein the management port allows configuration of the device.

50. Apparatus of claim 12 wherein the flow is a bidirectional flow.

51. Apparatus of claim 1 wherein the pre-stored patterns in pattern memory include one or more Berkeley Packet Filter (BPF) patterns or BPF derivatives.

52. Apparatus of claim 1 wherein the pre-stored patterns in pattern memory include one or more Berkeley Packet Filter Plus (BPF+) patterns.

53. Apparatus of claim 1 wherein the pre-stored patterns in pattern memory include one or more subsets of pre-stored patterns; the one or more subsets of pre-stored patterns being related to one or more packet flows.

54. Apparatus of claim 19 wherein the update module being adapted to update one or more of a plurality of rules in the policy engine.

55. Apparatus of claim 19 wherein the update module being adapted to update one or more of a plurality of messages.

56. Apparatus of claim 17 wherein the update module being adapted to update one or more of a plurality of system configuration registers.

57. Apparatus of claim 17 wherein the update module is coupled to the host interface port; the host interface port controlling the updating module.

58. Apparatus of 17 wherein the update module is coupled to a management port; the management port being coupled to an ingress network interface port.

59. Apparatus of claim 1 further comprising one or more of a plurality of stream processing blocks coupled to the rigid support member; the stream processing blocks comprising one or more of a plurality of stream processors wherein
each stream processor is characterized by a predefined functionality based upon at least an input sequence of data;
each of the stream processors are also characterized by providing an output sequence of data;
the output sequence of data is provided according to a predetermined algorithm; and
the predetermined algorithm has been provided by the predetermined functionality of each of the stream processors.

60. Apparatus of claim 59 wherein the predetermined functionality for each of the stream processors is programmable through software.

61. Apparatus of claim 59 wherein the stream processing blocks are provided within the network module.

62. Apparatus of claim 59 wherein the stream processors can be selected from one or more processes including:
a null stream processor; the null stream processor having a predetermined functionality wherein the output sequence of data is identical to the input sequence of data;
a decompression processor; the decompression processor having a predetermined functionality wherein the output sequence of data is typically larger than the input sequence of data and represents a sequence of data of some specific original size and condition;
a decoder; the decoder having a predetermined functionality wherein the output sequence of data is determined by the input sequence of data, according to the predetermined functionality;
a parser; the parser having a predetermined functionality wherein the output sequence of data is derived from the input sequence of data according to a predetermined specification;
a decryption processor; the decryption processor having a predetermined functionality wherein the output sequence of data is determined by the input sequence of data, according to the predetermined functionality;
a digest generator; the digest generator having a predetermined functionality wherein a summary of the input sequence of data is generated according to the predetermined functionality;
a checksum processor/verifier; the checksum processor or verifier having a predetermined functionality wherein the input sequence of data is checked for correctness;
a cyclic redundancy checksum (CRC) processor/verifier; the CRC processor or Verifier having a predetermined functionality wherein the input sequence of data is checked for corrected according to the cyclic redundancy checksum algorithm; and
a filter, the filter having a predetermined functionality wherein the output sequence of data is a reduced set of the input sequence of data.

63. Apparatus of claim 1 wherein the network applications comprise one or more security applications.

64. Apparatus of claim 1 wherein the applications are provided in one or more applications selected from:
intrusion detection;
intrusion prevention;
firewalling;
content filtering;
access control;
antivirus;
network monitoring;
traffic filtering;
spam filtering;
content classification;
application-level switching;
bandwidth/quality of service management;
surveillance; and
XML web services.

65. Apparatus of claim 1 wherein the network system is one or more network devices, the one or more network devices being selected from:
a firewall;
a network management system;
an intrusion prevention system;
a router;
a network switch;
a logging system;
a network appliance;
a security system;
an anti-virus system;
an anti-spam system;
an intrusion detection system;
a content filtering system;
a network monitoring system;
a file server;
a mail server;
a web server;
a proxy server; and
a storage area network system.

66. Apparatus of claim 1 wherein the host interface bus is selected from:
a peripheral components interface bus (PCI);
a compact peripheral components interface bus (compact PCI);
a peripheral components interface x bus (PCI-X);
a peripheral components interface express bus (PCI-express);
a universal serial bus (USB);
a small computer systems interface (SCSI); and
an ISA bus.

67. Apparatus of claim 13 further comprising a defragmentation device coupled to the rigid support member; the defragmentation device being provided by the network module, the defragmentation device being coupled to one or more ingress network ports; the flow classification device being coupled to the defragmentation engine; the defragmentation engine assembling one or more fragmented input packets into a whole unfragmented output packet according to some predetermined specification; the defragmentation engine passing such whole unfragmented output packet to the input of the protocol decoder.

68. Apparatus of claim 67 wherein the predetermined specification is the internet protocol specification.

69. Apparatus of claim 1 wherein the signature based pattern is selected from one or more of a plurality of patterns, the patterns being defined according to a language selected from:
a regular language;
a temporal regular language;
a Berkeley packet filter language;
a Linux packet filter language;
an approximate pattern language; and
a Perl compatible regular expression language.

70. A method for performing high throughput pattern matching wherein the high throughput pattern matching operation is performed using one or more of a plurality of patterns; the patterns being defined by a regular language; the regular language being implemented as a finite automaton; the finite automaton including a transition table representation of the regular language, the transition table describing a transition function for the finite automaton; the transition table being adapted to be stored in a compressed form; the compressed form being adapted such that the transition function of the finite automaton is able to be computed from the compressed form in a maximum time that is constant with respect to the size of the compressed form.

71. Method of claim 70 wherein the maximum time taken to compute the transition function is less than 40 nanoseconds.

72. Method of claim 70 wherein the compressed form has a best case compression ratio of better than 5:1, the best case compression ratio being the ratio of memory desired by the uncompressed form compared to the compressed form.

73. Method of claim 70 wherein the compressed form has a best case compression ratio of better than 5:1, the best case compression ratio being the ratio of memory desired by the uncompressed form compared to the compressed form, and the maximum time taken to compute the transition function is less than 40 nanoseconds.

74. Method of claim 70 wherein the compressed form has a smaller memory footprint than the transition table for a minimal deterministic finite automaton (DFA), a minimal DFA being the DFA of the one or more of the plurality of patterns, the minimal DFA having no more states than any other possible DFA representation of the said one or more of a plurality of patterns.

75. Apparatus of claim 1 wherein the pre-stored patterns are defined by a regular language; the regular language being implemented by a finite automaton; the finite automaton including a transition table representation of the regular language, the transition table describing a transition function for the finite automaton; the transition table being adapted to be stored in a compressed form; the compressed form being adapted such that the transition function of the finite automaton is computed from the compressed form in a maximum time that is constant with respect to the size of the compressed form.

76. Apparatus of claim 75 wherein the maximum time taken to compute the transition function is less than 40 nanoseconds.

77. Apparatus of claim 75 wherein the compressed form has a best case compression ratio of better than 5:1, the best case compression ratio being the ratio of memory desired by the uncompressed form compared to the compressed form.

78. Apparatus of claim 75 wherein the compressed form has a best case compression ratio of better than 5:1, the best case compression ratio being the ratio of memory desired by the uncompressed form compared to the compressed form, and the maximum time taken to compute the transition function is less than 40 nanoseconds.

79. Apparatus of claim 75 wherein the compressed form has a smaller memory footprint than the transition table for a minimal DFA, a minimal DFA being the DFA of the one or more of the plurality of patterns, the minimal DFA having no more states than any other possible DFA representation of the said one or more of a plurality of patterns.

80. Apparatus of claim 1 wherein the pre-stored patterns are defined by a regular language; the regular language being implemented by a finite automaton; the finite automaton including a transition table representation of the regular language, the transition table describing a transition function for the finite automaton; the transition table being adapted to be stored in a compressed form; the compressed form being adapted such that the transition function of the finite automaton is computed from the compressed form in constant time complexity; wherein the memory module is being provided by a one or more static memories, wherein if the static memories have a random access time of less than or equal to 5 nanoseconds, the apparatus guarantees the computation of the transition function is capable of sustaining a data rate of greater than or equal to 1.6 gigabits per second.

81. An apparatus for performing high throughput pattern matching wherein the high throughput pattern matching operation is performed using one or more of a plurality of patterns; the patterns being defined by a regular language; the regular language being implemented as a finite automaton; the finite automaton including a transition table representation of the regular language, the transition table describing a transition function for the finite automaton; wherein the patterns are represented as a single pattern database; the single pattern database comprising the patterns from one or more of a plurality of applications; the pattern matching operation being able to uniquely identify the application from the matching pattern.

82. Apparatus of claim 1 wherein the pre-stored patterns are represented as a single pattern database; the single pattern database comprising the patterns from one or more of a plurality of applications; the pattern matching operation being able to uniquely identify the application from the matching pattern.

83. A method for converting a network system into an accelerated signature based network system, the method comprising:
providing a network system, the network system comprising:
one or more input ports;
a host processor coupled to the one or more input ports;
a host memory coupled to the host processor;
a host interface bus coupled to the host processor; and
a host connector coupled to the host interface bus;
providing an integrated circuit apparatus for high throughput pattern matching for network applications, the apparatus comprising:
a rigid support member comprising a connector region, the connector region including a network connection region and a host connection region, the rigid support member having a selected width and a selected length, the selected width and selected length being adapted to couple via the connector region into a network system;
one or more hardware modules disposed onto and coupled to the rigid support member, the one or more hardware modules including:
a network interface module coupled to the rigid support member, the network interface module including one or more network interface ports, the one or more network interface ports being coupled via the connector region to a packet based network, the one or more network interface ports containing one or more ingress network ports;
a network interface bus coupled to the rigid support member, the network interface bus being adapted to interface the network interface module to the network module;
a network module coupled to the rigid support member, the network module being coupled to the network interface bus;
a network event module coupled to the rigid support member, the network event module being coupled to the network module;
a memory module coupled to the rigid support member, the memory module being coupled to the network event module and the network module, the memory module including a pattern memory, the pattern memory associated with a plurality of pre-stored patterns;
a host interface module coupled to the rigid support member, the host interface module being coupled to the network event module and/or the network module;
a host interface bus coupled to the rigid support member, the host interface bus being coupled to the host interface module, the host interface bus being capable of connecting to the host system via the connector region;
connecting the host interface connector region of the integrated circuit apparatus with the host connector on the network system to mechanically and electrically couple the host interface bus of the network system to the host interface bus of the integrated circuit apparatus;
transferring selected driver software to the network system, the driver software being configured to facilitate communication between the integrated circuit apparatus and the network system via the host interface bus; and
initializing the integrated circuit apparatus via the driver software.

84. The method of claim 83 wherein the network device is coupled to a network.

85. The method of claim 83 wherein the network device is free from a network connection.

86. The method of claim 83 further comprising operating the integrated circuit apparatus.

87. The method of claim 83 wherein the initialization of the integrated circuit apparatus includes the transfer of one or more of a plurality of pre-stored patterns from the network system to the integrated circuit apparatus.

88. Apparatus of claim 87 wherein the initialization of the integrated circuit apparatus also includes the transfer of one or more of a plurality of pre-stored protocol definitions from the network system to the integrated circuit apparatus.

89. Apparatus of claim 87 wherein the initialization of the integrated circuit apparatus also includes the transfer of one or more of a plurality of pre-stored rules from the network system to the integrated circuit apparatus.

90. A method for signature based pattern recognition using an integrated circuit apparatus, the method comprising:
providing an integrated circuit apparatus for high throughput pattern matching for network applications, the apparatus comprising:
a rigid support member comprising a connector region, the connector region including a network connection region and a host connection region, the rigid support member having a selected width and a selected length, the selected width and selected length being adapted to couple via the connector region into a network system;
one or more hardware modules disposed onto and coupled to the rigid support member, the one or more hardware modules including:
a network interface module coupled to the rigid support member, the network interface module including one or more network interface ports, the one or more network interface ports being coupled via the connector region to a packet based network, the one or more network interface ports containing one or more ingress network ports;
a network interface bus coupled to the rigid support member, the network interface bus being adapted to interface the network interface module to the network module;
a network module coupled to the rigid support member, the network module being coupled to the network interface bus;
a network event module coupled to the rigid support member, the network event module being coupled to the network module;
a memory module coupled to the rigid support member, the memory module being coupled to the network event module and the network module, the memory module including a pattern memory, the pattern memory associated with a plurality of pre-stored patterns;
a host interface module coupled to the rigid support member, the host interface module being coupled to the network event module and/or the network module;
a host interface bus coupled to the rigid support member, the host interface bus being coupled to the host interface module, the host interface bus being capable of connecting to the host system via the connector region;
transferring information from a packet based network to a network interface port;
transferring the information from the network interface port through a network interface bus;
receiving the information from the network interface bus at a processing unit;
identifying an association between one or more packets and a flow from the information using the processing unit;
reordering the one or more packets into one or more respective flows;
determining if the one or more packets for the one or more respective flows is associated with a signature based pattern stored in memory through a memory bus coupled to the processing unit, where upon the determining occurs using the memory having a random access time of less than 8 nanoseconds; and
initiating a signal to a policy engine if an association occurs.

91. The method of claim 90 further comprising decoding of the reordered flow from the processing unit according to one or more of a plurality of pre-determined protocol definitions, the pre-determined protocol definitions, the decoding process being adapted to extract salient features of interest from the reordered flow.

92. An apparatus for high throughput pattern matching in network applications, the apparatus comprising:
a network interface module having disposed therein one or more network interface ports adapted to be coupled to a packet based network; the one or more network interface ports including one or more ingress network ports, the network interface module configured to receive input network traffic;
a network module adapted to receive and transmit network traffic;
a memory module having stored therein a compressed transition table defining a finite automaton, the finite automaton representing a plurality of pre-stored patterns expressed in a regular language; and
a network event module comprising a feature extractor configured to perform one or more pattern matching operations on the input network traffic using the finite automaton; the feature extractor being further configured to detect matching patterns or signatures within the input network traffic and to output a signal indicating whether a match is detected.

93. The apparatus of claim 92 wherein the network interface module comprises a media access control layer and a physical access layer, the network interface module being associated with at least one of a plurality of networks including Ethernet (IEEE 802.X) network, SONET, and ATM.

94. The apparatus of claim 92 wherein the apparatus is adapted to operate on one or more streams of data concurrently.

95. The apparatus of claim 92 wherein the network interface module is characterized by a data rate equal to or greater than 10,000,000 bits per second.

96. The apparatus of claim 92 wherein the packet based network is an internet protocol (IP) network.

97. The apparatus of claim 92 wherein the packet based network is an asynchronous transfer mode (ATM) network.

98. The apparatus of claim 92 wherein the memory module includes one or more memory arrays selected from a group consisting of random access memories (RAM), content addressable memories (CAM), ternary content addressable memories (TCAM), and a combinations thereof.

99. The apparatus of claim 92 wherein the pre-stored patterns include one or more Berkeley Packet Filter (BPF) patterns or BPF derivatives.

100. The apparatus of claim 92 wherein the pre-stored patterns include one or more Berkeley Packet Filter Plus (BPF+) patterns.

101. The apparatus of claim 92 wherein the pre-stored patterns comprise one or more subsets of pre-stored patterns; the one or more subsets of pre-stored patterns being related to one or more packet flows.

102. The apparatus of claim 92 further comprising an update module coupled to the memory module, the update module further comprising a database manager configured to update one or more of a plurality of memories disposed in the memory module.

103. The apparatus of claim 102 wherein the update module further comprises an authentication module adapted to provide cryptographic authentication for the updates.

104. The apparatus of claim 92 wherein one or more of the ingress network ports is a management port.

105. The apparatus of claim 104 wherein the management port is operative to configure the apparatus.

106. The apparatus of claim 92 further comprising one or more stream processing blocks each comprising one or more stream processors each characterized by a predefined functionality based upon at least an input sequence of data and each adapted to generate an output sequence of data; wherein each output sequence of data is generated according to a predetermined algorithm provided by the predefined functionality of each of the stream processors.

107. The apparatus of claim 106 wherein the predefined functionality for each of the stream processors is programmable through software.

108. The apparatus of claim 106 wherein one or more of the stream processing blocks are disposed in the network module.

109. The apparatus of claim 106 wherein at least one stream processor is selected from a group consisting of:
a null stream processor having a predetermined functionality and configured to generate an output sequence of data that is identical to an input sequence of data;
a decompression processor having a predetermined functionality and having an output sequence of data that is typically larger than an input sequence of data, said decompression processor representing a sequence of data of some specific original size and condition;
a decoder having a predetermined functionality and having an output sequence of data that is determined by an input sequence of data in accordance with the predetermined functionality;
a parser having a predetermined functionality according to which an output sequence of data is derived from an input sequence of data according to a predetermined specification;
a decryption processor having a predetermined functionality according to which an output sequence of data is determined by an input sequence of data, according to the predetermined functionality;
a digest generator having a predetermined functionality according to which a summary of an input sequence of data is generated according to the predetermined functionality;
a checksum processor/verifier having a predetermined functionality according to which the input sequence of data is checked for correctness;
a cyclic redundancy checksum (CRC) processor/verifier having a predetermined functionality according to which an input sequence of data is checked or corrected according to a cyclic redundancy checksum algorithm; and
a filter having a predetermined functionality according to which an output sequence of data is a reduced set of input sequence of data.

110. The apparatus of claim 92 where in the network module comprises:
a flow classifier coupled to the one or more ingress network ports and adapted to receive one or more packets associated with a first sequence and assign each packet to one of a plurality of identified flows, said flow classifier being further adapted to identify a flow out of a plurality of flows to which the one or more packets belong; and
a flow assembler coupled to the flow classifier and adapted to reorder the one or more packets into a second sequence as determined by the identified flow.

111. The apparatus of claim 110 wherein the network module further comprises a protocol decoder adapted to process the one or more packets in the identified flow, said protocol decoder further adapted to provide payload information from the one or more packets according to one or more protocol definitions stored in the memory module.

112. The apparatus of claim 111 wherein the flow is a bidirectional flow.

113. The apparatus of claim 111 wherein the network module further comprises a flow post-processor configured to identify an association between one or more of a plurality of packets and to execute a post-processing algorithm in accordance with the identified association.

114. The apparatus of claim 113 further comprising a defragmentation module coupled to one or more ingress network ports and to the flow classifier; the defragmentation module adapted to assemble one or more fragmented input packets into an unfragmented output packet according to a predetermined specification; the defragmentation module passing the assembled unfragmented output packet to the protocol decoder.

115. The apparatus of claim 114 wherein the predetermined specification is the internet protocol specification.

116. The apparatus of claim 113 further comprising an update module adapted to update the plurality of pre-stored patterns; the updated patterns including at least one new pattern.

117. The apparatus of claim 116 wherein the update module is operable while the feature extractor is operable.

118. The apparatus of claim 116 wherein the update module is further adapted to update the configuration of the apparatus.

119. The apparatus of claim 116 wherein the update module is coupled to a host.

120. The apparatus of claim 116 wherein the update module is managed through a management port that is coupled to an ingress network interface port.

121. The apparatus of claim 116 wherein the update module is adapted to update a plurality of pre-stored protocol definitions; the updated protocol definitions including at least one new protocol definition.

122. The apparatus of claim 121 wherein the update module is adapted to operate concurrently with the protocol decoder.

123. The apparatus of claim 92 wherein the network event module is further configured to receive input network traffic in the form of one or more packets, wherein the memory module further comprises:
a feature memory associated with a plurality of pre-stored features; and
a rule memory associated with a plurality of pre-stored rules; wherein the feature extractor is configured to identify a feature association according to a feature extraction algorithm; the feature extraction algorithm identifying a feature association based upon examination of one or more packets according to some pre-determined functionality; the feature association identifying one or more of a plurality of pre-stored features; the pre-stored features being stored in a feature memory.

124. The apparatus of claim 123 further comprising:
a policy module coupled to the feature extractor and the memory module; the policy module identifying a rule association based upon the feature association identified by the feature extractor according to a policy algorithm, the policy algorithm identifying the rule association by examining the feature association according to some pre-determined functionality, the rule association identifying one or more of a plurality of pre-stored rules; the pre-stored rules being stored in a rule memory.

125. The apparatus of claim 124 further comprising an update module adapted to update the plurality of pre-stored patterns and the plurality of pre-stored rules; the updated patterns including at least one new pattern, the updated rules including at least one new rule.

126. The apparatus of claim 124 wherein the pre-stored patterns include one or more regular expressions.

127. The apparatus of claim 124 wherein the pre-stored patterns include one or more n-gram expressions, the n-gram expression being a tuple of symbols.

128. The apparatus of claim 124 wherein the pre-stored patterns include one or more temporal regular expressions.

129. The apparatus of claim 124 wherein one or more of the pre-stored rules is related to a counting component; the counting component including a counter and a threshold; the threshold being compared against the value of the counter.

130. The apparatus of claim 124 wherein the policy module is coupled to a host interface module and is adapted to supply the host interface module with the identified rule association.

131. The apparatus of claim 130 wherein the host interface module is coupled to a host connector region, where the host connector region is selected from a group consisting of:
peripheral components interface (PCI);
compact peripheral components interface (compact PCI);
peripheral components interface x (PCI-X);
peripheral components interface express (PCI-express);
universal serial bus (USB);
small computer systems interface (SCSI); and
ISA bus.

132. The apparatus of claim 124 wherein the feature extractor further includes an approximate pattern matching module adapted to perform approximate pattern matching on one or more of the pre-stored patterns.

133. The apparatus of claim 132 wherein the approximate pattern matching module is further adapted to perform approximate pattern matching on a file selected from at least text files of data, text streams of data, binary files of data, binary streams of data, audio streams of data, audio files of data, video streams of data, video files of data, multimedia streams of data, and multimedia files of data.

134. The apparatus of claim 132 wherein a measure of approximation in the approximate pattern matching is defined by an edit distance characterized by a number of insertions, deletions or substitutions to achieve exact pattern matching.

135. The apparatus of claim 132 wherein a measure of approximation in the approximate pattern matching is related to human perception.

136. The apparatus of claim 124 wherein the identified rule association signals an action causing a change in a state of the apparatus.

137. The apparatus of claim 136 wherein the action enables, for a pre-determined time period, selection of one or more pre-stored rules in the rule memory.

138. The apparatus of claim 124 wherein one or more of the pre-stored rules includes a temporal element.

139. The apparatus of claim 138 wherein the temporal element is related to at least one of a quantity of time, an absolute time, infinity, and zero.

140. The apparatus of claim 139 wherein the temporal element is related to a counting component; the counting component including a counter and a threshold; the threshold being compared to the counter; the combined temporal and counter components defining a rate of change.

141. The apparatus of claim 124 wherein the network module, the network interface module, the network event module and the network interface module are provided on a single integrated circuit.

142. The apparatus of claim 141 wherein the single integrated circuit is a network processing unit (NPU).

143. The apparatus of claim 141 wherein the single integrated circuit is an application specific integrated circuit (ASIC).

144. The apparatus of claim 141 wherein the single integrated circuit is a reconfigurable logic circuit.

145. The apparatus of claim 144 wherein the reconfigurable logic circuit is a field programmable gate array (FPGA).

146. The apparatus of claim 92 wherein the one or more network interface ports further comprise one or more egress network ports coupled to the packet based network.

147. The apparatus of claim 146 wherein the one or more egress network ports is a response port adapted to facilitate communications to a remote network system via a signal.

148. The apparatus of claim 147 wherein the remote network system is selected from a group consisting of firewall, network management system, intrusion prevention system, router, network switch, and logging system.

149. The apparatus of claim 147 wherein the signal includes one or more messages.

150. The apparatus of claim 149 further comprising an update module adapted to update the one or more messages.

151. The apparatus of claim 149 wherein the one or more messages include one or more messages selected from the group consisting from:
an access control list update message;
an audit message;
an event message;
an alarm message;
a status message;
a query message;
an update message;
a management message;
an error message; and
a warning message.

152. The apparatus of claim 147 wherein the signal is related to a match detected by the feature extractor.

153. The apparatus of claim 147 wherein the signal is related to an output of the network event module.

154. The apparatus of claim 92 wherein the network applications comprise one or more security applications.

155. The apparatus of claim 92 wherein the network applications are selected from a group consisting of:
intrusion detection;
intrusion prevention;
firewalling;
content filtering;
access control;
antivirus;
network monitoring;
traffic filtering;
spam filtering;
content classification;
application-level switching;
bandwidth/quality of service management;
surveillance; and
XML web services.

156. The apparatus of claim 92 wherein the apparatus is adapted to communicate with a network system selected from a group consisting of:
a firewall;
a network management system;
an intrusion prevention system;
a router;
a network switch;
a logging system;
a network appliance;
a security system;
an anti-virus system;
an anti-spam system;
an intrusion detection system;
a content filtering system;
a network monitoring system;
a file server;
a mail server;
a web server;
a proxy server; and
a storage area network system.

157. The apparatus of claim 92 wherein the signatures are selected from a plurality of patterns defined according to a language selected from:
a regular language;
a temporal regular language;
a Berkeley packet filter language;
a Linux packet filter language;
an approximate pattern language; and
a Perl compatible regular expression language.

158. The apparatus of claim 92 wherein the compressed transition table has a smaller memory footprint than an uncompressed transition table for a minimal DFA, a minimal DFA being the DFA of the one or more of the plurality of patterns, the minimal DFA having no more states than any other possible DFA representation of the said one or more of a plurality of patterns.

159. The apparatus of claim 92 wherein the compressed transition table is adapted such that the transition function of the finite automaton is computed from the compressed transition table in a maximum time that is constant with respect to the size of the compressed transition table.

160. The apparatus of claim 159 wherein the transition function is computed in less than 40 nanoseconds.

161. The apparatus of claim 159 wherein the compressed transition table has a compression ratio of greater than 5:1, the compression ratio being the ratio of memory desired by the uncompressed transition table compared to the compressed transition table.

162. The apparatus of claim 159 wherein the compressed transition table has a compression ratio of greater than 5:1, the compression ratio being the ratio of memory desired by the uncompressed transition table compared to the compressed transition table, and wherein the transition function is computed in less than 40 nanoseconds.

163. The apparatus of claim 92 wherein the compressed transition table is adapted such that the transition function of the finite automaton is computed from the compressed transition table in a maximum time that is constant with respect to the size of the compressed transition table; the transition function supporting a sustained data rate of greater than or equal to 1.6 gigabits per second.

164. The apparatus of claim 92 wherein the pre-stored patterns are represented as a single pattern database; the single pattern database comprising the patterns from one or more of a plurality of network applications; the pattern matching operation being able to uniquely identify the network application from the matched pattern.

165. An apparatus configured to perform high throughput pattern matching using one or more of a plurality of patterns defined by a regular language implemented as a finite automaton; the finite automaton including a transition table representation of the regular language, the transition table describing a transition function for the finite automaton; wherein the patterns are represented as a single pattern database comprising the patterns from one or more of a plurality of applications; the apparatus adapted to uniquely identify the application.

166. A method for performing high throughput pattern matching wherein the high throughput pattern matching operation is performed using one or more of a plurality of patterns; the patterns being defined by a regular language; the regular language being implemented as a finite automaton; the finite automaton including a transition table representation of the regular language, the transition table describing a transition function for the finite automaton; the transition table being adapted to be stored in a compressed form; the compressed form being adapted such that the transition function of the finite automaton is able to be computed from the compressed form in a maximum time that is constant with respect to the size of the compressed form.

167. Method of claim 166 wherein the maximum time taken to compute the transition function is less than 40 nanoseconds.

168. Method of claim 166 wherein the compressed form has a best case compression ratio of better than 5:1, the best case compression ratio being the ratio of memory desired by the uncompressed form compared to the compressed form.

169. Method of claim 166 wherein the compressed form has a best case compression ratio of better than 5:1, the best case compression ratio being the ratio of memory desired by the uncompressed form compared to the compressed form, and the maximum time taken to compute the transition function is less than 40 nanoseconds.

170. Method of claim 166 wherein the compressed form has a smaller memory footprint than the transition table for a minimal deterministic finite automaton (DFA), a minimal DFA being the DFA of the one or more of the plurality of patterns, the minimal DFA having no more states than any other possible DFA representation of the said one or more of a plurality of patterns.

171. A method for performing high throughput pattern matching wherein the high throughput pattern matching operation is performed using a feature extractor, the feature extractor being configured to operate on input data using a compressed transition table defining a finite automaton, the finite automaton representing a plurality of pre-stored patterns expressed in a regular language, the feature extractor being further configured to detect matching patterns or signatures within the input data and to output a signal indicating whether a match is detected.

172. A method for converting a network system into an accelerated signature based network system, the method comprising:
providing a network system, the network system comprising:
one or more input ports;
a host processor coupled to the one or more input ports;
a host memory coupled to the host processor;
a host interface bus coupled to the host processor; and
a host connector coupled to the host interface bus;
providing an apparatus for high throughput pattern matching, the apparatus comprising:
a network interface module having disposed therein one or more network interface ports adapted to be coupled to a packet based network; the one or more network interface ports including one or more ingress network ports, the network interface module configured to receive input network traffic;
a network module adapted to receive and transmit network traffic;
a memory module having stored therein a compressed transition table defining a finite automaton, the finite automaton representing a plurality of pre-stored patterns expressed in a regular language;
a network event module comprising a feature extractor configured to perform one or more pattern matching operations on the input network traffic using the finite automaton; the feature extractor being further configured to detect matching patterns or signatures within the input network traffic and to output a signal indicating whether a match is detected;
an update module; and
a host interface module coupled to a host interface connector;
connecting the host connector of the network system to the host connector of the high throughput pattern matching apparatus;
transferring selected driver software to the network system, the driver software being configured to facilitate communication between the high throughput pattern matching apparatus and the network system via the host interface connector; and
initializing the high throughput pattern matching apparatus via the driver software.

173. The method of claim 172 wherein initializing the high throughput pattern matching apparatus includes transferring one or more of a plurality of compressed transition tables from the network system to the high throughput pattern matching apparatus.

174. A method for signature based pattern recognition using an integrated circuit apparatus, the method comprising:
providing an apparatus for high throughput pattern matching, the apparatus comprising:
a network interface module having disposed therein one or more network interface ports adapted to be coupled to a packet based network; the one or more network interface ports including one or more ingress network ports, the network interface module configured to receive input network traffic;
a network module adapted to receive and transmit network traffic;
a memory module having stored therein a compressed transition table defining a finite automaton, the finite automaton representing a plurality of pre-stored patterns expressed in a regular language;
a network event module comprising a feature extractor configured to perform one or more pattern matching operations on the input network traffic using the finite automaton; the feature extractor being further configured to detect matching patterns or signatures within the input network traffic and to output a signal indicating whether a match is detected;
the network module further comprising a flow classifier coupled to the one or more ingress network ports and adapted to receive one or more packets associated with a first sequence and assign each packet to one of a plurality of identified flows, said flow classifier being further adapted to identify a flow out of a plurality of flows to which the one or more packets belong;
the network module further comprising a flow assembler coupled to the flow classifier and adapted to reorder the one or more packets into a second sequence as determined by the identified flow;
the memory module further comprises a feature memory associated with a plurality of pre-stored features;
the memory module further comprises a rule memory associated with a plurality of pre-stored rules; wherein the feature extractor is configured to identify a feature association according to a feature extraction algorithm; the feature extraction algorithm identifying a feature association based upon examination of one or more packets according to some pre-determined functionality; the feature association identifying one or more of a plurality of pre-stored features; the pre-stored features being stored in a feature memory; and
a policy module coupled to the feature extractor and the memory module; the policy module identifying a rule association based upon the feature association identified by the feature extractor according to a policy algorithm, the policy algorithm identifying the rule association by examining the feature association according to some pre-determined functionality, the rule association identifying one or more of a plurality of pre-stored rules; the pre-stored rules being stored in a rule memory;
receiving one or more packets from a packet based network to a network interface port;
receiving the one or more packets at the network module;
identifying an association between the one or more packets and assigning a flow identifier to each of the one or more packets using the flow classifier;
reordering the one or more packets into one or more respective flows using the flow assembler;
performing pattern matching on network traffic comprising the one or more packets for the one or more respective flows using the feature extractor; and
outputting a signal from the feature extractor to the policy module indicating the detection of a matching pattern or signature within the input network traffic.

175. A method for high throughput pattern matching in network applications, the method comprising:
receiving input network traffic;
performing one or more pattern matching operations on the received input network traffic using a finite automaton, wherein the finite automaton is defined by a compressed transition table stored in a memory module, wherein the finite automaton represents a plurality of pre-stored patterns expressed in a regular language;
detecting matching patterns or signatures within the input network traffic; and
outputting a signal indicating whether a match is detected;

176. The method of claim 175 further comprises:
receiving an input sequence of data derived from the received input network traffic;
generating an output sequence of data according to a predetermined algorithm provided by a predefined functionality of a stream processor, wherein the stream processor is provided by a stream processing block.

177. The method of claim 176 wherein the predefined functionality for the stream processor is programmable through software.

178. The method of claim 176 wherein the stream processor is selected from a group consisting of:
a null stream processor having a predetermined functionality and configured to generate an output sequence of data that is identical to an input sequence of data;
a decompression processor having a predetermined functionality and having an output sequence of data that is typically larger than an input sequence of data, said decompression processor representing a sequence of data of some specific original size and condition;
a decoder having a predetermined functionality and having an output sequence of data that is determined by an input sequence of data in accordance with the predetermined functionality;
a parser having a predetermined functionality according to which an output sequence of data is derived from an input sequence of data according to a predetermined specification;
a decryption processor having a predetermined functionality according to which an output sequence of data is determined by an input sequence of data, according to the predetermined functionality;
a digest generator having a predetermined functionality according to which a summary of an input sequence of data is generated according to the predetermined functionality;
a checksum processor/verifier having a predetermined functionality according to which the input sequence of data is checked for correctness;
a cyclic redundancy checksum (CRC) processor/verifier having a predetermined functionality according to which an input sequence of data is checked or corrected according to a cyclic redundancy checksum algorithm; and
a filter having a predetermined functionality according to which an output sequence of data is a reduced set of input sequence of data.

179. The method of claim 175 further comprises:
receiving one or more packets associated with a first sequence;
assigning each packet to one of a plurality of identified flows;
identifying a flow out of a plurality of flows to which the one or more packets belong; and
reordering the one or more packets into a second sequence as determined by the identified flow.

180. The method of claim 179 further comprises:
processing the one or more packets in the identified flow; and
providing payload information from the one or more packets according to one or more protocol definitions.

181. The method of claim 180 further comprises:
identifying an association between one or more of a plurality of packets; and
executing a post-processing algorithm in accordance with the identified association.

182. The method of claim 175 further comprises updating the plurality of pre-stored patterns, wherein the updated patterns including at least one new pattern.

183. The method of claim 182 further comprises updating the configuration of the apparatus.

184. The method of claim 175 further comprises identifying a feature association based upon examination of input network traffic using a feature extraction algorithm, the feature extraction algorithm is based on some pre-determined functionality, the feature association identifying one or more of a plurality of pre-stored features.

185. The method of claim 184 further comprises identifying a rule association based upon the feature association identified by the feature extractor according to a policy algorithm, the policy algorithm identifying the rule association by examining the feature association according to some pre-determined functionality, the rule association identifying one or more of a plurality of pre-stored rules.

186. The method of claim 185 further comprises updating the plurality of pre-stored patterns and the plurality of pre-stored rules, the updated patterns including at least one new pattern, the updated rules including at least one new rule.

187. The method of claim 185 further comprises performing approximate pattern matching on one or more pre-stored patterns.

188. The method of claim 187 wherein performing approximate pattern matching includes measuring the level of approximation, wherein the method of measuring the level of approximation is selected from a group comprising:
calculating an edit distance characterized by a number of insertions, deletions or substitutions to achieve exact pattern matching; and
quantifying some level of human perception of the pattern matching process.

189. The method of claim 183 further comprises reconfiguring a logic circuit.

190. The method of claim 175 further comprises communicating with a network system selected from a group consisting of:
a firewall;
a network management system;
an intrusion prevention system;
a router;
a network switch;
a logging system;
a network appliance;
a security system;
an anti-virus system;
an anti-spam system;
an intrusion detection system;
a content filtering system;
a network monitoring system;
a file server;
a mail server;
a web server;
a proxy server; and
a storage area network system.

191. The method of claim 175 further comprises computing the transition function of the finite automaton using the compressed transition table in a maximum time that is constant with respect to the size of the compressed transition table.

192. The method of claim 191 wherein the transition function is computed in less than 40 nanoseconds.

193. The method of claim 191 wherein the compressed transition table has a compression ratio of greater than 5:1, the compression ratio being the ratio of memory desired by the uncompressed transition table compared to the compressed transition table.

194. The method of claim 191 wherein the compressed transition table has a compression ratio of greater than 5:1, the compression ratio being the ratio of memory desired by the uncompressed transition table compared to the compressed transition table, and wherein the transition function is computed in less than 40 nanoseconds.

195. The method of claim 175 wherein the compressed transition table is adapted such that the transition function of the finite automaton is computed from the compressed transition table in a maximum time that is constant with respect to the size of the compressed transition table, the transition function supporting a sustained data rate of greater than or equal to 1.6 gigabits per second.

196. The method of claim 175 further comprises identifying uniquely a network application from the matched pattern, wherein one or more of a plurality of network applications are used to derive pre-stored patterns.
